(19) United States
(12) Patent Application Publication
(10) Pub. No.: US 2025/0087711 A1
(43) Pub. Date: Mar. 13, 2025

(54) INTEGRATED ELECTROCHEMICAL CELL POWER GENERATION AND ELECTROLYSIS SYSTEMS

(71) Applicants: CZERO, INC., Fort Collins, CO (US); NEXCERIS, LLC, Lewis Center, OH (US)

(72) Inventors: Nick ECHTER, Fort Collins, CO (US); Michael SPRENGEL, Fort Collins, CO (US); Chris TURNER, Windsor, CO (US); Jeff ROGERS, Woodland Park, CO (US); Caleb ALVARADO, Fort Collins, CO (US); Scott SWARTZ, Columbus, OH (US); Gene ARKENBERG, Newark, DE (US); Chad SELLERS, Columbus, OH (US)

(21) Appl. No.: 18/727,305

(22) PCT Filed: Jan. 6, 2023
(86) PCT No.: PCT/US2023/010339

§ 371 Date: Jul. 8, 2024

Related U.S. Application Data
(60) Provisional application No. 63/297,525, filed on Jan. 7, 2022.

(51) Int. Cl. H01M 8/02; H01M 8/04; H01M 8/2475

(52) U.S. Cl. CPC H01M 8/02; H01M 8/04; H01M 8/2475

(57) ABSTRACT

Electrochemical cell systems (51) and electrochemical cell processes are described as applicable to power generation or electrolysis modes with systems that have a containment vessel interior space multiple electrochemical cell stack, stack inlet plenum (43) that can accommodate thermal expansion and contraction in an economical way and that can provide a substantially equivalent environment for each stack inlet as well as can include, if desired, either or all of a vessel external compression stack mount possibly configured as a cathode outlet manifold (111) configured as a stack mount, a fully accommodative thermal expansion-contraction electrochemical cell stack mount possibly configured with external springs (91), and even the possibility of an axial flow adjuster such as a gradation plate (99) for better operation.

### PRIORITY CLAIM

This application is a PCT International Patent Application claiming priority to and the benefit of U.S. Provisional Application No. 63/297,525, filed Jan. 7, 2022, such patent application and any priority case hereby incorporated herein by reference in their entirety.

### GOVERNMENT LICENSE RIGHTS

This invention was made with government support under ARPA-E INTEGRATE contract DE-AR0000956 awarded by the Department of Energy. The government has certain rights in the invention.

### FIELD OF THE INVENTION

The inventive technology described herein generally relates to the field of electrochemical cell processes and integrated Solid Oxide Fuel Cell (SOFC) stacks (or other type of fuel cells) including Gas Turbine (GT) systems intended for high efficiency power production as well as Solid Oxide Electrolyzer Cells (SOEC)(or other type of electrolyzers) intended for gas or hydrogen production. This document serves as a disclosure of several embodiments related to an integrated Solid Oxide Fuel Cell (SOFC) stack (or other type of fuel cell) and Gas Turbine (GT) system intended for a variety of purposes, including high efficiency power production and electrolysis developed by the inventors. Further, while some of the embodiments are related to the integrated SOFC/GT system, others could be used in isolation with a standalone pressurized or unpressurized SOFC, SOEC, or other type of fuel cell system. Furthermore some of the embodiments may be used as part of an SOEC electrolyzer system such as for gas or hydrogen production. This inventive technology also relates to systems and methods for integrated Solid Oxide Fuel Cell (SOFC) stack (or other type of fuel cell) and Gas Turbine (GT) systems intended for high efficiency power production used in isolation with a standalone SOFC (or other type of fuel cell) system or integrated to a SOFC/GT system.

### BACKGROUND OF THE INVENTION

Solid Oxide Fuel Cells are advanced high-temperature (between, but not limited to, 500-1000° C.) electrochemical devices which may efficiently convert fuel (predominantly hydrogen) into electricity. While relatively efficient, SOFC's high operating temperature, their need for a constant flow of hot air to supply oxygen for the electrochemical reaction, and the fact that not all the fuel supplied to the SOFC be consumed may leave areas for system and efficiency improvements. Both the waste heat, and the unconsumed fuel, may be utilized to increase system efficiency by integrating a gas turbine into the system. Additionally, while the SOFC ultimately consumes hydrogen in the electrochemical reaction, the system's high operating temperatures may also be conducive to reforming fuels such as natural gas into hydrogen which may be consumed within the SOFC stack. Solid Oxide Electrolyzer Cells (SOEC's) are closely related to SOFCs and effectively reverse the process to convert steam and electricity into hydrogen (which may be used as a fuel) and oxygen. They may also produce some power. Many of the embodiments disclosed herein are applicable to SOEC's as well as SOFC's. In this document SOFC is often used as a generic term which should be understood to encompasses both SOFC's and SOEC's.

### SUMMARY OF THE INVENTION

In general, the inventive technology may involve both apparatus and methods in a variety of embodiments to achieve efficient and robust integrated Solid Oxide Fuel Cell (SOFC) stack (or other type of fuel cell) and Gas Turbine (GT) systems intended for high efficiency power production and also to achieve integrated solid oxide electrolyzer cell (SOEC) systems to produce gases, fuels, possibly oxygen, and hydrogen. The invention can apply to a variety of different type of electrochemical cells and processes. For example disclosed are technologies that are applicable to planar solid oxide fuel cell stacks and solid oxide electrolysis stacks, and stacks which operate at high temperature (perhaps 600 to 900° C.). These stacks may be comprised of a multitude of ceramic planar components (oxygen ion conducting ceramic electrolyte plates) with electrodes on opposite faces. These planar solid oxide cells typically are stacked and sealed with metallic interconnects, current collectors, and shims to define gas flow paths such that two different gases can be flowed on opposite faces of each of the planar cells and electrochemical reactions can be made to happen. Various types of solid oxide electrochemical systems and cells can be used in the embodiments within both general concepts of a power generating system such as a solid oxide fuel cell or an electrolysis system such as a solid oxide electrolysis cell. Details of the different types are mentioned later.

While one goal includes creating a high efficiency power generation system by integrating an SOFC with a CT, the methods and system architecture disclosed go beyond that goal and are applicable in a host of other contexts. The objectives of the inventing team were primarily to develop a system design which maximized system efficiency while eventually producing the system at an economically viable price point, and secondarily to minimize complexity and maximize robustness. Further, this technology is now expanded to encompass Solid Oxide Electrolyzer or Electrolysis Cells (SOEC's), which may be closely related to SOFC's and which effectively reverse the process to convert steam and electricity into hydrogen (which may be used as a fuel) and oxygen. Many of the embodiments disclosed herein are applicable to SOEC's as well as SOFC's, so, in this document SOFC is often used as a generic term which encompasses both SOFC's and SOEC's.

### BRIEF DESCRIPTION OF THE FIGS.

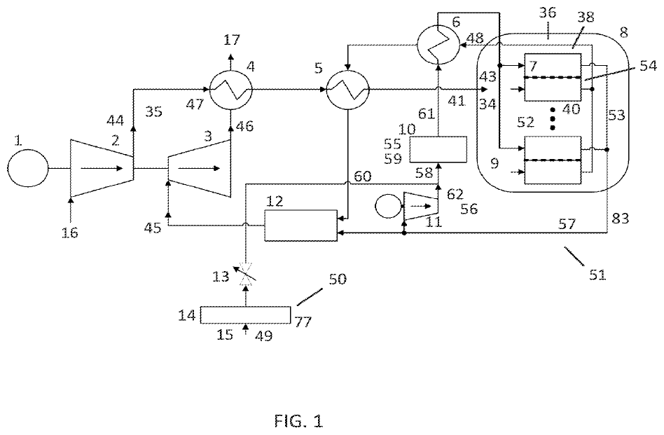

FIG. 1 is an exemplary embodiment of a base system schematic.

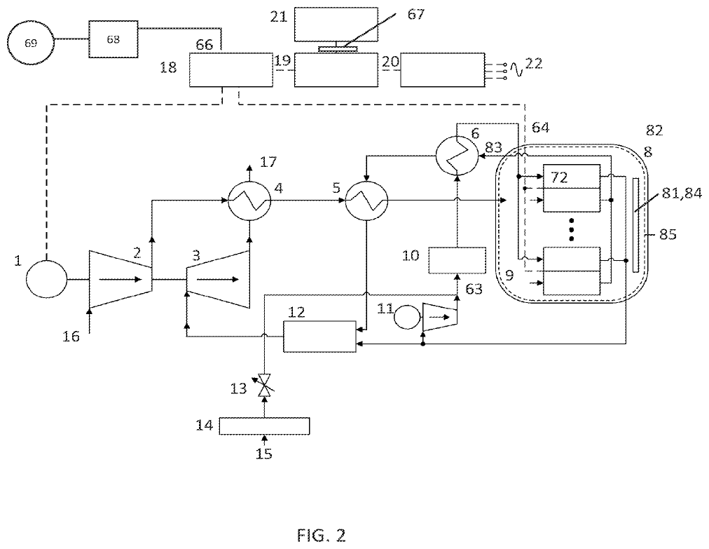

FIG. 2 is an exemplary embodiment of a system schematic illustrating power export.

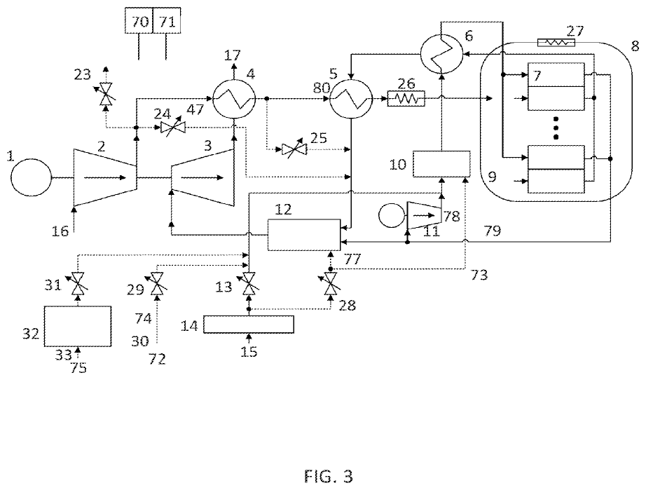

FIG. 3 is an exemplary embodiment of a system schematic illustrating startup and shutdown components.

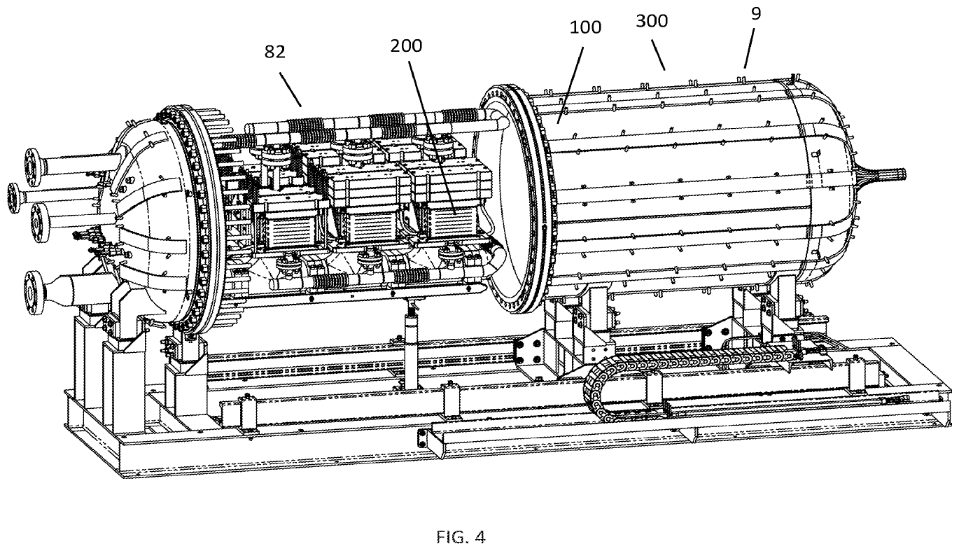

FIG. 4 is an exemplary embodiment of a solid oxide fuel cell assembly and pressure vessel.

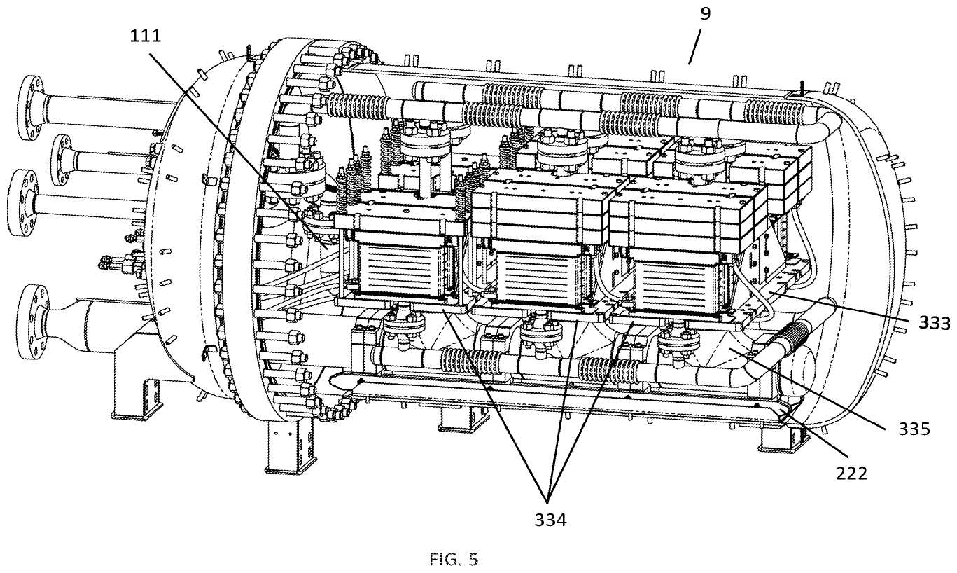

FIG. 5 is another exemplary embodiment of a solid oxide fuel cell assembly and pressure vessel.

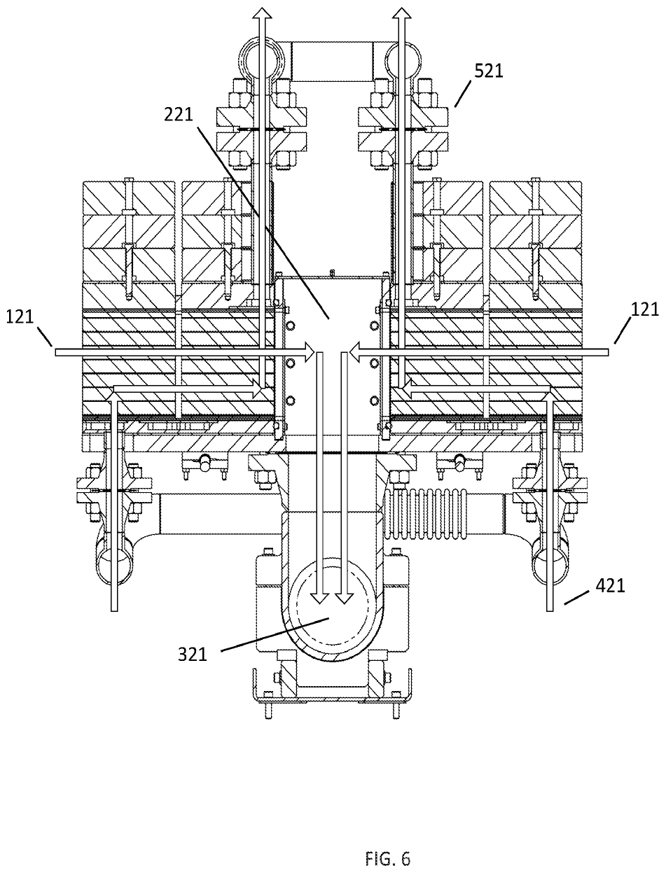

FIG. 6 is an exemplary embodiment of a solid oxide fuel cell flow path.

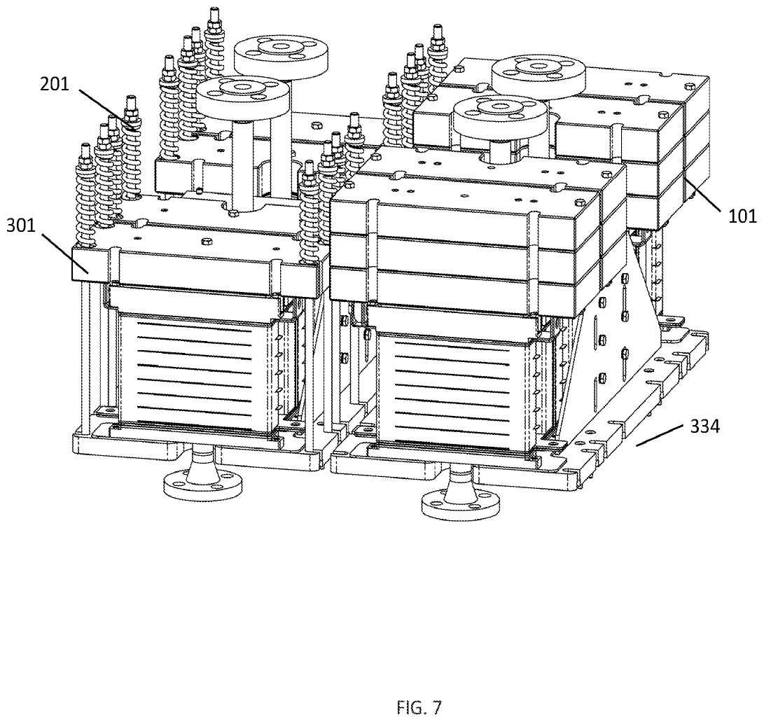

FIG. 7 is an exemplary embodiment of a solid oxide fuel cell stack shelf.

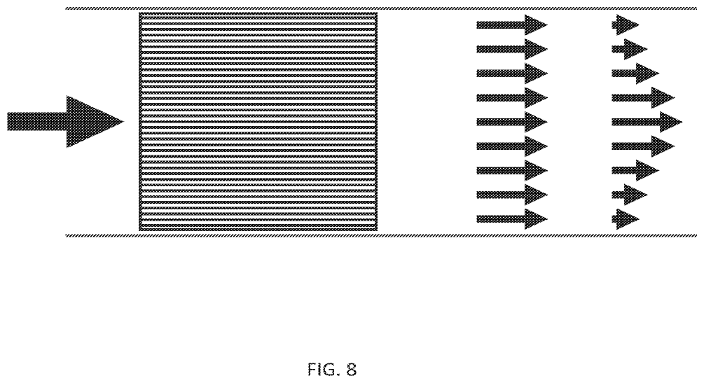

FIG. 8 is an exemplary illustration of a conventional cathode flow and stack temperature distribution.

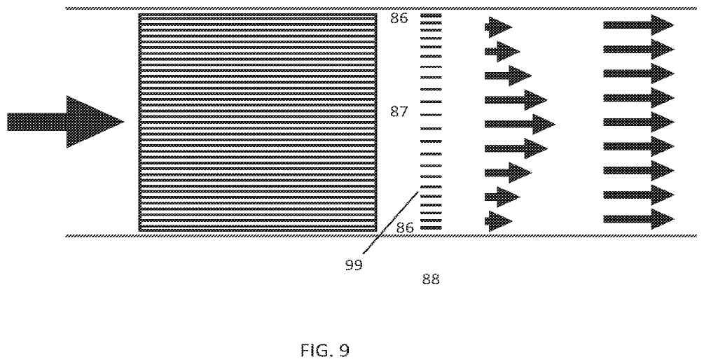

FIG. 9 is an exemplary illustration of a simplified representation of cathode flow and stack temperature distribution for one embodiment of the present technology.

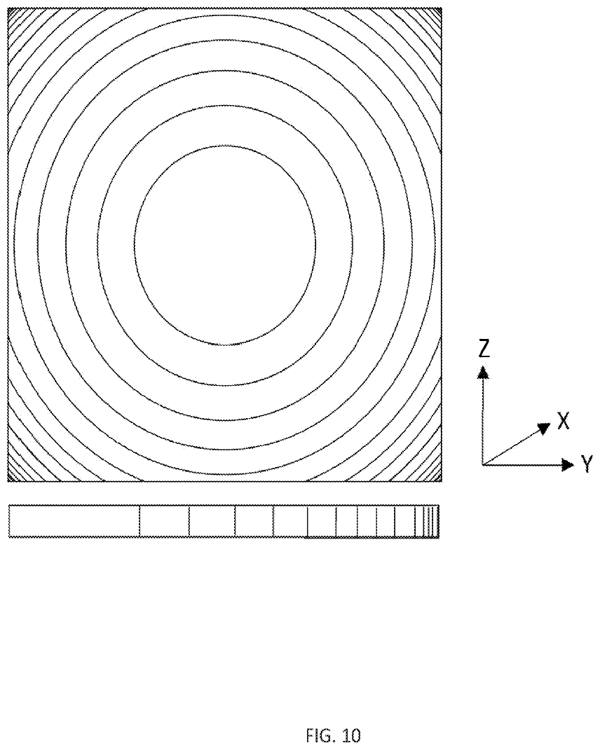

FIG. 10 is an exemplary illustration of an example gradated flow distribution for one embodiment of the present technology.

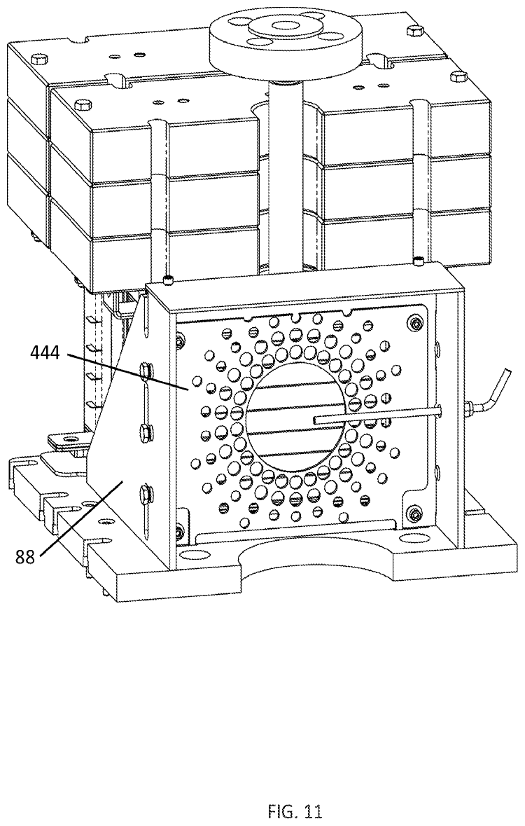

FIG. 11 is an exemplary embodiment of an axial flow adjuster in one embodiment of the present technology.

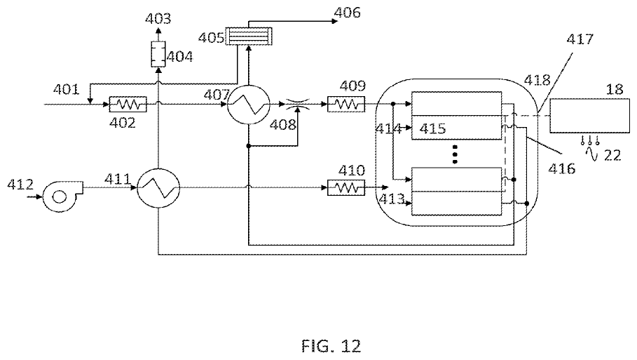

FIG. 12 is an exemplary embodiment of an SOEC system schematic.

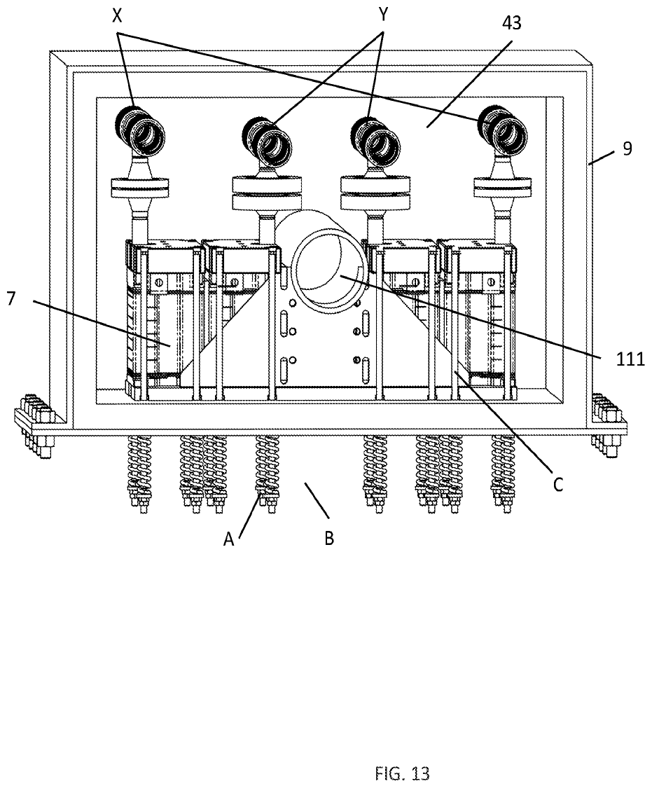

FIG. 13 is an exemplary illustration of a stack compression mechanism.

### BRIEF DESCRIPTION OF THE PREFERRED EMBODIMENTS

It should be understood that embodiments include a variety of aspects, which may be combined in different ways. The following descriptions are provided to list elements and describe some of the embodiments of the application. These elements are listed with initial embodiments; however, it should be understood that they may be combined in any manner and in any number to create additional embodiments. The variously described examples and preferred embodiments should not be construed to limit the embodiments of the application to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

Generally, electrochemical cell systems can be most basically understood as having first function and second function electrodes. One type of electrode can be considered as having a first function, and another type of electrode can be considered as having a second function. For example, from a fluid and chemical perspective one type of electrode cell collection can be what herein is termed an oxygen cell collection that has a function of conducting an oxygen-involved operation or function and another type of electrode cell collection can be termed a fuel cell collection that has a function of conducting a fuel-involved operation or function. In these types of first and second functions, either the oxygen-type or the fuel-type can be considered as the first function because such cells can operate in reverse orders. Further, the oxygen can serve to foster a fuel oxidation type of event, and the fuel can be an appropriately compatible substance, likely any hydrogen or carbon containing substance, often both such as a hydrocarbon containing substance. Similarly from an electrical perspective, the first and second functions can be those of a cathode and an anode where, again, either can be configured as the first function and the opposite one can be configured as the second function-types of electrode. As is known, electrodes can be layered or configured in stacks which may be comprised of pluralities of first function electrode elements and pluralities of second function electrode elements. As is known, such electrode stacks in these types of cell stacks have inlets and outlets for each of the two types of electrodes. Thus, the stacks may include a stack first function electrode inlet such as for the first function electrode stack, a stack first function electrode outlet again for the first function electrode stack, a stack second function electrode inlet such as for the second function electrode stack, and a stack second function electrode outlet also for the second function electrode stack. These type of inlets can be understood from FIG. 6 where the first function electrode element is configured as a cathode element in an oxygen stack and thus the first function electrode inlet is shown as the area at the beginning of the arrow as the cathode inlet (121) and the corresponding first function electrode outlet is shown as the area at the end of the arrow as the cathode outlet flowing into the outlet plenum (221). Similarly the second function electrode element, perhaps configured as an anode element in a fuel stack, could have a second function electrode inlet and a corresponding second function electrode outlet such as can be understood from FIG. 13. These inlet and outlet areas an be manifolded as explained later.

Using a solid oxide fuel cell (SOFC) as an initial design, one embodiment of the base system schematic for the Solid Oxide Fuel Cell (SOFC) and Gas Turbine (GT) system is shown in FIG. 1. This system (51) may be comprised of multiple components of course including the SOFC stacks (7). These are made up of individual electrochemical cells (52) fluidically connected in series, as one option, to form stacks (53), which may then electrically connect via interconnection (34) in series and/or parallel to produce part of the system's electrical power. An important aspect of SOFCs may be that the electrochemical reaction may be effectively exothermic. Whatever portion of the fuel's energy consumed within the stack is not converted into electricity, may be converted into heat which may be released into the stack and principally carried away by the anode and cathode streams. The SOFC stacks may be integrated into the middle of the gas turbine flow path (35) both to maximize system thermodynamic efficiency, and to enable the stacks (53) to operate under pressurized conditions in a pressurized area (36) to improve their electrochemical efficiency. In some embodiments other optimized benefits may also be present due to integrating SOFC stacks into the middle of the gas turbine flow path. Due to the mechanical design of the SOFC stacks they may operate with relatively low differential pressure between their interior (38) and exterior (40), as such they may be placed within a pressure vessel (9) pressurized by the cathode inlet flow (41) or operated under ambient pressure. This pressure vessel (9), or more generally, a containment vessel (9) can be configured to removably contain at least a portion of the plurality of connected individual electrochemical cell stacks, and may also serve as an intake plenum (43), or more precisely, a containment vessel interior space multiple electrochemical cell stack, stack first function electrode inlet plenum such as for the first function electrode stack, in this embodiment depicted as element (43). In this manner the intake plenum (43) or containment vessel interior space multiple electrochemical cell stack, stack first function electrode inlet plenum, can serve to ensure even flow distribution and to recover additional heat lost by hotter components within the pressure vessel (9) assembly.

As can be understood, by using the more generic terms first function and second function relative to the electrodes, various different configurations are encompassed. For example, the oxygen electrode elements can be configured in a stack. This stack of oxygen electrode elements can be considered a stack of first function electrode elements. And this can provide cathode elements. And the fuel electrode elements can also be configured in a stack and this stack of fuel electrode elements can be considered a stack of second function electrode elements, and furthermore, this stack can provide anode elements. This type of configuration could present a SOFC system. Electrically reversing functions, a stack of oxygen electrode elements can be considered a stack of first function electrode elements and can provide the anode elements, and the stack of fuel electrode elements can be considered a stack of second function electrode elements and can provide the cathode elements. This type of configuration could present a SOEC system. The chemically opposite can be true as well, a stack of fuel electrode elements can be considered a stack of first function electrode elements and can provide the cathode elements, and a stack of oxygen electrode elements can be considered a stack of second function electrode elements and can provide the anode elements. This type of configuration could present a SOEC system. Once again, electrically reversing the prior stated functions, a stack of fuel electrode elements can be considered a stack of first function electrode elements and can provide the anode elements, and a stack of oxygen electrode elements can be considered a stack of second function electrode elements and can provide the cathode elements. This type of configuration could present a SOFC system.

Electrochemical cell stacks may include a plurality of connected individual electrochemical cell stacks which may be connected fluidically, electrically, or most likely both. Here, for example, the plurality of connected individual electrochemical cell stacks can be configured as stacks selected from: series electrically connected electrochemical cell stacks; series fluidically connected electrochemical cell stacks; parallel electrically connected electrochemical cell stacks; parallel fluidically connected electrochemical cell stacks; and any permutations and combinations of the above even in a particular system. Thus in establishing a system for operation, configurations can be selected, purchased, operated, or even individually built so that the system can be considered as providing series electrically connected electrochemical cell stacks; providing series fluidically connected electrochemical cell stacks; providing parallel electrically connected electrochemical cell stacks; providing parallel fluidically connected electrochemical cell stacks; and any permutations and combinations of these.

Further, turbomachinery (1, 2, 3) may be an additional component within some systems. A compressor (2) and/or a turbine (3) can supply potentially required compressed air (44) from an air inlet (15,16) to support both the gas turbine cycle, as well as the SOFC. The turbine (3) can take the pressurized and heated exhaust stream (45) and can create mechanical power used, in part, to power the turbomachinery's compressor (2), while the turbine's remaining power may be converted into electricity via an electric generator (1). This motor/generator (1) may operate both as a generator to produce electricity while the system is operational, and as a motor to power the compressor (2) during startup and perhaps shutdown.

Due to physics, the turbine (3) may be unable to extract all the available heat from the combustor exhaust stream (45). To improve efficiency a turbine recuperator (4) may be added to transfer much of the remaining heat from the turbine exhaust (46) to the compressor exhaust (47) where it may be recirculated within the system (51) and also exhausted (17). The SOFC stacks (53) may require a relatively high operating temperature to facilitate the electrochemical reactions, and consequently the incoming cathode flow (41), such as from the compressor (2) may need to be pre-heated sufficiently to prevent undesirable cooling of the stack (53). Part of the electrochemical cell system may thus involve the step of utilizing a turbine recuperator (4) in part of a process. The turbine recuperator (4) may be capable of supplying some, or most, of this preheat depending on how the system (51) is operated. If the turbine inlet temperature is relatively high, and the turbine's pressure ratio relatively low (and consequently the turbine outlet temperature is high), then the turbine recuperator (4) may supply most of the preheat to the cathode inlet flow (41). However, if the turbine inlet temperature is lower, or the pressure ratio is higher, then the system may further include a cathode recuperator (5) which may be integrated into the system or may be utilized by the system (51) to transfer additional heat from the cathode outlet stream (48) to the inlet stream (41).

In some embodiments, the system (51) may be supplied by various, possibly gaseous fuels (49) including natural gas. In embodiments utilizing natural gas, the fuel (49) may first pass through a desulfurizer (14) to remove sulfur which could contaminate the catalyst in the SOFC, or may include a step of utilizing a desulfurizer or even desulfurizing to achieve the same. Further, fuel may be metered by a main natural gas valve (13), and may then enter the system (51) as the principal fuel source. In some embodiments it may be beneficial that the fuel be properly conditioned by some type of conditioner (50) before entering the SOFC stack (53) to ensure the stack (53) operates effectively and robustly as intended. In some embodiments, important considerations for the stack (53) as it relates to fueling may include: having the SOFC's electrochemical reaction predominantly directly consume hydrogen, and having the stack constructed with catalysts (54) which may convert such as methane and water into carbon monoxide and hydrogen in a strongly endothermic (heat absorbing) reaction which if it occurs in too great a concentration may cause overcooling and may damage through thermally induced stresses. Further, hydrocarbons higher than methane may have an increased propensity to cause detrimental carbon depositions (coking).

In some embodiments, a reformer (10) may be included in this system or may be involved as a step in the operation of the system (51) to condition the fuel (49) before it enters the SOFC stacks (53) to help address stack fueling issues. A reformer (10) may also be included as a catalyst reactor (55) which may support several reactions including reactions such as converting higher hydrocarbons and water into carbon monoxide and hydrogen, perhaps using endothermic reactions, converting methane and water into carbon monoxide and hydrogen, perhaps using the endothermic methane steam reforming reaction, and converting carbon monoxide and water into carbon dioxide and hydrogen using the exothermic water gas shift reaction. The water and heat required to facilitate these reactions may be supplied by: recirculating, such as by having a recirculation (56) of a portion of the anode effluent (57) (which may contain heat from the system, and water from the SOFC's electrochemical reaction); and mixing that recirculation with the fresh natural gas (58) which then may flow into the reformer (10). The reformer (10) may be an adiabatic (or near adiabatic, minimizing heat or mass transfer of the system) device in which the inlet gas (60) species and temperature, in conjugation with the equilibrium chemistry between the various reactions, may determine the composition and temperature at the reformer's outlet (61).

Flow recirculation (62) may be used by means of a recirculation blower (11) or an ejector. By setting the amount of anode effluent recirculation (57), the conditions at the reformer outlet (61) can be controlled. This flowrate may be set to ensure all higher hydrocarbons are cracked, that sufficient hydrogen is recirculated inflow recirculation (62) to prevent localized fuel depletion within the stacks (53), and to leave an appropriate amount of methane in the stream (48) to help cool the SOFC to enable more power to be produced, but not so much that the stacks (53) are overcooled and damaged. In an adiabatic design, the outlet of the reformer (10) may be significantly cooler than the inlet (63) due to endothermic reactions and may be heated up to the SOFC's operating temperature to prevent damage to the stacks (53). This may be accomplished with the anode heat exchanger (6) which may heat the anode inlet (64, 421) with the cathode outlet stream (48). In such embodiments, the step of utilizing an anode heat exchanger (6) in part of the process may be included.

A fraction of the fuel (49) supplied to the SOFC may remain unconsumed as it leaves the stacks (53). Whatever fuel is not recirculated by the recirculation blower (11) may flow into a combustor (12), thus providing the step of utilizing a combustor (12), where it may be mixed with air or the like from the cathode exhaust in the cathode outlet stream (48), and burned. This combustion process may both consume the remaining fuel (65), and may further heat the already hot cathode exhaust in cathode outlet stream (48), which may then flow into the turbine (3) to extract a degree of the remaining power.

FIG. 2 is an exemplary embodiment of another SOFC-type system (51) with a schematic illustrating power export. FIG. 2 adds select components which may be beneficial to control and export power from the SOFC and motor/generator (1). Control of power flow to and from the motor/generator (1), and consequently turbomachinery speed, may be accomplished through power electronics (18) which may include a drive, perhaps a variable frequency drive (66). Similarly, the load placed on the SOFC, and consequently power produced by, and fuel consumed within, the stacks (53) may be accomplished through a separate set of power electronics (18). In some embodiments, the system (51) may be capable of exporting power either as DC or AC and in either islanding or grid-synced modes. In an embodiment exporting AC power, especially to voltages common in industrial settings such as 480V three phase, the voltages, such as from the motor generator (1), or a generator and the SOFC may need to be boosted by power electronics (18) to a higher level such as 750V. In the case of an AC system, an inverter (20) may be used to create the required frequency/voltage from the DC Bus. To stabilize the DC bus (19), batteries (21) may be connected to the bus through their own battery power electronics (67). For grid (22) connected systems, the system (51) may be operated in such a manner that the supervisory control system (68) (with or without operator input(69)) may command that a certain amount of power be generated and exported. However, for islanding systems, the system (51) may need to respond reactively to the external electric loads placed on it. In this case, to prevent the SOFC/GT system from undergoing rapid transients, batteries (21) may be used to supply the short-term electrical demands while the supervisory control system (68) slowly adjusts the power output from the system (51) to both supply external loads such as its grid (22) or otherwise, and to recharge the batteries (21) as required.

FIG. 3 is an exemplary embodiment of a SOFC-type system (51) schematic illustrating and including startup components (70) and shutdown components (71) which would be connected as those skilled in the art would well understand. In some embodiments, additional components may be beneficial to start up and shut down the system (51), and may be included as additional safety mechanisms, as shown in FIG. 3. Once the system (51) is fully operational it may become thermally self-sustaining. However, to reach the point where the SOFC may begin to produce power (and generate excess heat) the stacks (53) may first need to be sufficiently heated. This heating may be accomplished primarily through a resistive pressure vessel startup pre-heater (27) attached directly to the pressure vessel (9). The pressure vessel (9) itself may be the largest thermal heat sink within the system (51) and may be pre-heated such as by pressure vessel startup pre-heater (27) to prevent heat being drawn from the stacks (53). As the pressure vessel's shell (8) heats up, so do all the components within the vessel (including the stacks (53) and piping). This approach can allow the system (51) to be smoothly heated without firing any other equipment. In some embodiments, an additional source of heat may also come from the cathode startup pre-heater (26) if desired.

In some embodiments, to start up the GT system (51) partially independent of the SOFC, the reformer (10) may be deired to be at the appropriate inlet conditions before fueling, and so a supplemental natural gas valve (28) may be included to supply fuel (49) directly to the combustor (12). Once the SOFC stacks (53) and reformer (10) exceed a certain temperature during startup and shutdown, the catalysts (54) may need to be protected from oxygen to prevent degradation. This may be accomplished through a purging system (72) with gas (30) which may primarily supply nitrogen to displace atmospheric or other oxygen. Secondarily, a small amount of hydrogen may be added to the flow via as a first reaction supplement (73) such as to create a reducing environment to consume any oxygen which may leak into the system (especially through the SOFC assembly). This purging flow (74) may be supplied into the system (51) during startup and shut down by a valve that introduces a flow of reducing gas(29). Such a reducing gas can have a variety of compositions, including but not limited to compositions such as 5% (or other percentages) of H₂ in N₂ as but one example. For the reformer (10) to begin converting higher hydrocarbons to lower molecular weight species, and perhaps creating the hydrogen required to initialize the SOFC, some water (33) may first need to be mixed via a second reactor supplement (75) (with or without a first reactor supplement (73)) with the fuel (49) before it enters the reformer. This may be accomplished via a startup steam generator (32) and metered by a H₂O valve (31).

In support of system safety, several additional valves may be incorporated into the system. First, there may be a bleed air valve (23). This valve (23) may serve two key functions, but is not limited to these functions. First, in the event that the compressor (2) approaches a destructive stall/surge event, the valve (23) may be opened to increase flow from the compressor (2) and move the compressor condition away from its stall/surge condition or line. Second, in the event that the load on the motor/generator (1) is lost when the system (51) is operational, which could otherwise cause over speeding of the turbomachinery, (1,2,3) the bleed air bypass valve (23) may be opened to add additional load to the compressor to compensate for the loss of the generator load. A hot air bypass valve (25) may be added to allow flow from the compressor (2) via compressor exhaust to largely bypass the SOFC during startup and shutdown. As this hot air bypass valve (25) may then be slowly closed so an increasing percentage of flow from the hot air bypass compressor as compression exhaust (47) may be diverted through the SOFC until all flow passes through the compressor to the SOFC path once the valve (25) is fully closed. In some embodiments, a cold air bypass valve (24) may be added to the system to bypass flow around the turbine recuperator (4) to help further control temperatures within the system.

Note that the components and configuration described above are not an exhaustive list of all components required or possible for operation or system configurations. In certain embodiments the present technology may include but is not limited to select variants on the system architecture detailed below:
The recirculation blower (11) may be replaced by an ejector (78). An ejector (78) can be a device which may entrain flow from a suction port by accelerating then decelerating flow from a motive stream. In this case the motive flow, and the power to drive the ejector, (78) may come from the incoming fuel or perhaps natural gas flow (77) while the suction port could be connected to the anode outlet (29, 521) or anode manifold outlet (79). This approach has the potential to be cheaper and more robust than the recirculation blower, (11) however it removes one control variable and may be less efficient.
The number of SOFT stacks, (53) and their electrical configuration and type, is completely variable based on the desired system efficiency and cost. Similarly, the power produced by the turbomachinery (1,2,3) relative to the SOFC is variable.
The reformer (10) may be isothermal (e.g., external heat transfer maintains the internal gas at a constant temperature) rather than adiabatic. In this case the amount of external reforming could likely be reduced resulting in less methane to cool the stack (53). However, under certain conditions this may be desirable and would also eliminate the need for an anode heat exchanger (6).
If sufficient heat is present in the turbine outlet, or turbine exhaust, (46) via the GT flow path (35), or sufficient heat may passively be transferred from the components within the pressure vessel (9) to the cathode inlet stream, or flow (41) then the cathode recuperator may be able to be removed. Removing this component may be desirable as it may add additional pressure drop (e.g., power loss) to the system (51) as well as additional external heat loss (due to the increased surface area) and added system cost.
The cathode pre-heater (26) may be removed and only the pressure vessel pre-heater (27) used. This may reduce the response time of adding additional heat into the gas flow, but it can remove a component (added cost) and can reduce the pressure drop through the system (51).
The hot and cold air bypass valves (25,24) may potentially be removed depending on the control strategies employed for startup, shutdown, and load transients.
This system (51) may also be powered by alternative fuels, (49) and alternate fuel streams, or incoming fuel flows (77). If a hydrogen fuel stream was available, then the reformer (10) could be eliminated, and the hydrogen used directly. With a change in the reformer (10) formulation, other hydrocarbon fuels may also be used.
The fuel stream or flow (77) may be pre-heated via the system's exhaust (17) or exhaust gas stream or through a heat exchanger with any other flow path in the system.
The system may be operated unpressurized rather than pressurized.
The system may operate in reverse such as in converting steam (or steam and carbon dioxide) and electricity into oxygen and hydrogen (or hydrogen and carbon monoxide) as part of an SOEC system, as those skilled in the art would readily understand.

In some embodiments, due to the SOFC (and SOEC) stack's (53) mechanical design, systems (51) may generally have roughly the same internal and external pressures to minimize the mechanical stress and stack leakage which could otherwise be induced by a differential pressure. As the stacks (53) within the SOFC/GT system operate under pressure, this may necessitate housing the stacks within a pressure vessel (9). Given that the stacks (53) are hot, and may be placed within a pressure vessel, (9) careful design is beneficial in creating the system (51). Some of the considerations in this regard may include:
To ensure consistent operation, the cathode and anode flow distribution between the various stacks (53) may need to be uniform. This may be difficult to achieve due to the complexity of manifolding all the stacks (53) in a confined area while also minimizing pressure drop (which has a direct impact on system efficiency).
To maximize efficiency, it may be essential that the pressure vessel (9) is well insulated against external heat losses and this has specific sub considerations:
   The pressure vessel (9) may be pressurized by a gas turbine (3) meaning there may be a pressuring at flow path (80) between the two elements. Prior work has shown that any insulation within the pressure vessel (9) has the potential to become dislodged and enter the turbine (3) or other components which can be damaged.
   As the system (51) is shutting down the pressure within the pressure vessel (9) drops. If this occurs too rapidly any insulation within the pressure vessel may undergo explosive decompression as the air trapped within and behind the insulation expands, that may result in damage to the insulation
   The mechanical structure within the pressure vessel (9) can be quite complex and may be difficult to insulate.
Any leaks of hydrogen or other fuels into the pressure vessel (9) may potentially become quite dangerous, especially if they were to accumulate to explosive levels within a portion of the pressure vessel (9) without much air flow or become trapped and concentrated within a section of internal insulation.
As the system (51) heats up to operating temperature, significant thermal growth often occurs causing all the stacks (53) to move away from one another. This may pose challenges for any manifolding and support structure within the pressure vessel (9). It may be beneficial to carefully design the system (51) to ensure that the thermal growth of components inside the vessel (9) do not cause thermally induced stresses that may damage the hardware.
During shutdown there may be a potential for compressed cathode air to flow backwards through the compressor (20) as the internal pressurized gas expands and escapes back to atmosphere. If flow through the cathode portion of the stack (53) is reversed during this event, and combustion products enter the stack, (53) this may damage the SOFC.
The stacks may require a compression force to prevent the individual cell layers from separating. A compression mechanism (81) may be required to also survive as the stack thermally expands to operating temperature, and more challengingly survive the hot conditions within the stack (53) or pressure vessel (9) without adversely affecting the compression force.

FIG. 4 is an exemplary embodiment of a solid oxide fuel cell assembly (82) and pressure vessel (9,100). In such a system, some of the above considerations may be taken into account such as in the pressure vessel embodiment shown in FIG. 4. As implemented here, it may be beneficial to utilize the pressure vessel (100) which may be a ‘containment vessel interior space multiple electrochemical cell stack, stack first function electrode inlet plenum’ itself as the cathode intake plenum (200). This may provide several advantages including ensuring a uniform flow distribution between the various stacks, (53), ensuring a unform flow distribution within each stack between the various cells (52), and the like. It can also eliminate the sizable cathode manifolding which may otherwise be required to distribute flow to or from the various stacks (53). With this design, all components within the pressure vessel (100) may be surrounded by cathode inlet flow (41) before this flow enters the stacks (53). This may allow the cathode inlet flow (41) to recover a degree of heat from the surrounding components which may otherwise be lost. This may also serve to add additional heat to the incoming cathode air of the cathode inlet flow (41) and may eliminate an otherwise costly cathode recuperator (5).

As especially shown in FIG. 13, configurations can be selected, purchased, operated, or built so that the system can be considered as establishing a ‘containment vessel interior space multiple electrochemical cell stack, stack first function electrode inlet plenum’ and even providing a plenum that accomplishes the steps of fully surrounding and containing each of the plurality of stack first function electrode inlets.

In further embodiments, a system may be configured to also or separately fully surround and contain the plurality of stack second function electrode outlets. Further, systems can include a variety of manifolds. There can be: a first function electrode outlet manifold likely connected to each of the stack first function electrode outlets; a second function electrode inlet manifold likely connected to each of the stack second function electrode inlets; and a second function electrode outlet manifold likely connected to each of the stack second function electrode outlets. Similarly, configurations can be selected, purchased, or built so that the system can be considered as establishing a first function electrode outlet manifold, connecting the first function electrode outlet manifold to each of the stack first function electrode outlets, establishing a second function electrode inlet manifold, and connecting the second function electrode inlet manifold to each of the stack second function electrode inlets, and establishing a second function electrode outlet manifold, and connecting the second function electrode outlet manifold to each of the stack second function electrode outlets. When such manifolds are included, the system can be configured to accomplish the steps of surrounding at least a portion of the second function electrode inlet manifold, and surrounding at least a portion of the second function electrode outlet manifold. Other embodiments may also include a ‘containment vessel interior space multiple electrochemical cell stack, stack first function electrode inlet plenum’ configured to surround each of the second function electrode inlet manifold, and the second function outlet manifold. Further embodiments may be configured to establish a substantially equivalent environmental intake condition for each of the plurality of first function electrode elements or may include a step of establishing a substantially equivalent environmental inlet condition for each of the first function electrode elements.

In some embodiments with the cathode inlet flow (41) surrounding all the components, the internal temperatures may range between 750-850° C. with the cooler temperatures exterior to the stack, (53) and the hotter temperatures at the stack's (53) outlet (83) (due to the heat released within the SOFC). This approach is referred to here as the ‘hot pressure vessel’ concept. With this embodiment all or most of the insulation (300) may now be placed on the pressure vessel's exterior. This may have several advantages including greatly simplifying the insulation's (300) design (e.g., it may be placed around a relativity smooth cylindrical body, rather than surrounding the intricate components within the pressure vessel (100)). Placing the insulation outside of the pressure vessel (100) may eliminate the possibility of the insulation (300) experiencing explosive decompression or otherwise entering the air stream and damaging components within the system (51). Similarly, by not placing the insulation (300) within the pressure vessel, hydrogen and other fuels cannot become trapped within the insulation (300) creating a potential hazard. Further, any hydrogen which leaks from the anode manifolding into the pressure vessel (100) may immediately combust due to the presence of oxygen in the cathode intake plenum containing the cathode inlet flow (41) well above hydrogen's autoignition temperature of 585° C. (while this sounds dangerous, it may be preferable to a large amount of fuel collecting and detonating within the pressure vessel (100)).

In another embodiment, another advantage of the hot pressure vessel concept is that the majority of the system's capacitance (volume) may be held within the cathode intake plenum containing the cathode inlet flow (41). During a rapid depressurization, flow may leave through both the GT's compressor (2) and turbine (3). However, as the cathode intake plenum containing the cathode inlet flow (41) may be the largest reservoir of compressed air, this air may flow both through the stack (53) to the turbine, (3) and backwards to the compressor (2). As such, reverse flow through the stacks (53) should not occur.

FIG. 5 is another exemplary embodiment of a solid oxide fuel cell assembly (82) and pressure vessel (9). In some embodiments, as the system heats to operating temperature, all components within a heated area, perhaps within the pressure vessel (9), may expand away from one another. To address this, embodiments can include a fully accommodative thermal expansion-contraction electrochemical cell stack mount. Through such a mount, the system may be capable of substantially fully, or fully accommodatively thermally expanding and contracting the plurality of connected individual electrochemical cell stacks within the containment vessel interior space multiple electrochemical cell stack, stack first function electrode inlet plenum as temperatures change to and from ambient to maximum operating temperature. As also shown in FIG. 5, beyond just accommodating thermal expansion and contraction of the stacks, embodiments can have elements to address expansion and contraction of manifolds as well. As shown in FIG. 5, the pressure vessel (9), and even the stack first function electrode inlet plenum (43), may be sized to include not only any or all (as shown) of the various manifolds, but each of their thermal expansions and contractions. In such an embodiment, the manifolds can be totally, mostly, or partially within the containment vessel interior space multiple electrochemical cell stack, stack first function electrode inlet plenum. Further the manifolds can be designed as substantially fully accommodative thermal expansion-contraction manifolds such as with accordion type expansion tubes, expansion joints, or other known elements. Further, the pressure vessel (9) or stack first function electrode inlet plenum (43) can have a fully dimensionally accommodative thermal expansion-contraction interior space. And, as can be understood from FIG. 13 where only some of the manifold(s) is/are inside the plenum (such as anode inlet manifold (89) and anode outlet manifold (90)), systems can be operated to achieve any or all of the steps of: substantially fully accommodatively thermally expanding and contracting at least a portion of a second function electrode inlet manifold within the containment vessel interior space multiple electrochemical cell stack, stack first function electrode inlet plenum; substantially fully accommodatively thermally expanding and contracting at least a portion of the second function electrode outlet manifold within said containment vessel interior space multiple electrochemical cell stack, stack first function electrode inlet plenum; or the like with respect to any of the manifolds.

As mentioned above, embodiments can include a fully accommodative thermal expansion-contraction electrochemical cell stack mount. This can accommodate expansion-contraction of the stacks themselves. As shown in FIGS. 4, 5 and 6, embodiments may include mounting all the stacks (53) on a manifold, perhaps such as the cathode outlet manifold (111) which then may act as a principal support structure (as shown in FIG. 5) with or without a shelf on the manifold. More generally, embodiments of the invention may be configured to include any or all of: a substantially singular thermal expansion coefficient mount, a manifold stack mount, and/or a stack shelf on which each of the plurality of connected individual electrochemical cell stacks may be mounted. A manifold stack mount, one examples of which can be the cathode outlet manifold (111) used as a mount as shown, may be a first function electrode outlet manifold stack mount, a second function electrode inlet manifold stack mount, or a second function electrode outlet manifold stack mount. The step of mounting the plurality of connected individual electrochemical cell stacks by a substantially singular thermal expansion coefficient mount, such as by using a singular material, may allow more uniform expansion-contraction to be accommodated. Additionally, in operating a system the step of utilizing a manifold stack mount may be achieved, and this may include utilizing a first function electrode outlet manifold stack mount, utilizing a second function electrode inlet manifold stack mount, or utilizing a second function electrode outlet manifold stack mount. There may be multiple benefits to configurations generally having an electrochemical cell support manifold, and perhaps: an electrochemical cell support outlet manifold or achieving the step of supporting the electrochemical cell stacks by a first function electrode outlet manifold; having a first function electrode outlet manifold stack mount; establishing a first function electrode outlet manifold stack mount; having a substantially fully accommodative thermal expansion-contraction second function electrode outlet manifold; or substantially fully accommodatively thermally expanding and contracting the second function electrode outlet manifold within the containment vessel interior space multiple electrochemical cell stack, stack first function electrode inlet plenum. First, using but one example, as nothing is constraining the cathode outlet manifold (111) from expanding along the length of the pressure vessel, (9) it may be free to expand without inducing internal mechanical stresses. This may eliminate the need for expensive expansion joints on the cathode side in this design. Second, by incorporating both the cathode outlet manifold, (111) and the stack support structure, into a single component such as the pressure vessel (9), the system's complexity, size, and cost may be reduced. Additionally, the cathode outlet manifold (111) may support the stack assembly (82) when the structure is cooled, and the pressure vessel body retracted such as on a roller element (222) via a step of rolling componentry within a containment vessel, on a slide element (such as shown in FIG. 4) via a step of sliding componentry with a containment vessel, or some other type of interface, enabling easy access.

Also visible in FIG. 5 is one potential supporting and mounting structure (333) approach for the stacks (53). Two (or more/less) stacks (53) may be mounted loosely to a shelf (334) (allowing for thermal growth), with a total of three shelfs (though more or less are possible) are shown in FIG. 5. In some embodiments, this may include a stack shelf on which each of the plurality of connected individual electrochemical cell stacks are mounted or may include the step of utilizing a stack shelf on which each of the plurality of connected individual electrochemical cell stacks are mounted. In some embodiments, these shelves (334) may then be mounted to the cathode outlet header (335) of the cathode outlet (or other) manifold (111). A cross-sectional view of the shelf (334) and mounting structure (533) is shown in FIG. 6. This shows how the cathode inlet and flow (121) enters though the front of the stacks, (53) and then flows into an outlet plenum (221) where flows from two stacks may be combined before exiting into the cathode outlet manifold (321).

Due to the SOFC stacks' (53) design (alternating anode, electrolyte, cathode, current collector, flow path, and seal layers fused together) a compressive load may be required to prevent separation of the various elements due to thermal expansion and pressure forces. This is shown as a gravity load in FIGS. 4, 5, 6 and 11, and a spring compressive load in FIGS. 7 and 13. To prevent damage to the stack, several hundred pounds (a few hundred kilograms) of compressive force may be required. This force (within some bounds) may be maintained from the point when the stack (53) is first fused together during assembly, though transport and installation, all the way to operating temperature within the SOFC/GT system, (51) and back down to ambient temperature. This challenge is exacerbated by the high temperature environment which the compression mechanism (81) (as indicated in FIGS. 4 and 7) may be required to survive in. It should be noted that the same compression mechanism (81) may not need to be applied during both transport and installation/operation. Embodiments may include a compressive stack mount or the step of compressing connected individual electrochemical cell stacks. Focusing on the methods employed during installation and operation, embodiments, such as that shown in FIG. 13, may include a compressive tie rod (94), a compression element, and or a spring element (91) as well as possibly the steps of utilizing a compressive tie rod, utilizing a compression element, and or utilizing a spring element (91).

In certain embodiments, it may desired to provide the compression element, perhaps the spring element (91) on the exterior (92) of a vessel or a plenum. Thus embodiments may have an at least part vessel external compressive stack mount as well as the step of at least part vessel external compressing each connected individual electrochemical cell stack. In some embodiments, such as shown in FIG. 13, this may include at least part vessel external spring element (91) or the step of at least part vessel external utilizing a spring element. Further embodiments may include a thermal barrier (93) configured to substantially thermally isolate at least part of the vessel external compressive stack mount or the step of substantially thermally isolating the step of at least part vessel external compressing each of the connected individual electrochemical cell stacks from the containment vessel interior space multiple electrochemical cell stack, stack first function electrode inlet plenum. Embodiments may also include a non-high temperature compressive stack mount and or the step of non-high temperature compressing each of the connected individual electrochemical cell stacks.

FIG. 7 is an exemplary embodiment of a solid oxide fuel cell stack shelf (334). Two methods are proposed and shown in FIG. 7: springs (201) and deadweight (101). Deadweight (101) may be simply a mass placed on the top of the stack to provide the requisite compressive force through gravitational loading. The benefit of this approach is that it is simple and highly reliable, unaffected by temperature variations, and continues to apply the same load even as the stack thermally expands and contracts. One possible downside is that it may be heavy (requiring additionally support structure) and may not be suitable for mobile applications in part due to inertial loading which could cause the deadweight (101) to momentarily lift off the top of the stack (53) removing the critical compressive load.

As mentioned above, the compression mechanism (81) can be configured as, among other possibilities, a gravity based compression or a spring based compression or combinations thereof. As shown in FIG. 7, a series of compression springs (201) may be utilized to provide part or all the requisite compressive force. The benefit of this approach is that springs are far lighter than deadweight (101) as they use internal strain to store the compressive force. Similarly due to their light weight, and the fact that they do not rely on gravity to apply the compressive load, they are more immune to inertial loading and are more suitable for mobile applications. One possible difficulty in implementing springs (201) may be the high operating temperatures experienced within the SOFC/GT systems. At these temperatures the strength of suitable spring material greatly drops and material creep may cause a loss in compressive force over time if the springs (201) are not suitably designed (though springs have already been designed which will operate under these conditions for this application). The left stack in FIG. 7 shows a hybrid design to reduce the spring (201) requirements where a portion of the compressive load is applied by spring deadweight (301), and the remaining load is applied by springs (201).

In some embodiments multiple variations of the pressure vessel (9) and stack mounting designs discussed above may be possible. Embodiments may include variants such as but not limited to the following:
One potential concern with the hot vessel concept is material cost. The pressure vessel's cost may be reduced by switching to a lower temperature alloy (cheaper) and installing a refractory liner (85) or thermal barrier (93), each as shown in FIG. 13. This liner could serve as high-temperature insulation layer keeping the pressure vessel's (9) shell (8) at a lower temperature and permitting a potentially more cost-effective design.
In addition to utilizing deadweights (101) and springs (201) to provide stack compression, this force may also be applied by other mechanisms such as pneumatic actuation. With a pneumatic design a pneumatic actuator (84) may be installed on each stack (53) and connected to pneumatic source (85) outside of the pressure vessel (9) as shown in FIG. 2. This approach may allow for the compressive load to be dynamically controlled (by changing the air pressure), verified (by monitoring the air pressure) and easily compensates for changes in temperatures and thermal expansion.
   Other aspects to mounting the stacks can include:
In the embodiment illustrated shows just six stacks (53) on three shelves. In other embodiments this approach may be adapted to more or fewer stacks (53) as required to meet the desired system power level, efficiency and/or hydrogen (or other gas) generation rate.
The vessel design may be used as part of either and SOFC or and SOEC system.
The cathode's inlet (121) and outlet (321) may be reversed (e.g., the inlet plenum (shown in FIG. 6 as element (121)) and outlet manifold shown in FIG. 6 as element (321) may be reversed such that flow enters through the manifold and exits into the plenum).
The cathode (41, 48) and anode (64,79) flows may be swapped such that the cathode flow is contained within the anode lines (shown in FIG. 6 as elements (421,521)) and the anode flow is contained within the cathode lines (shown in FIG. 6 as elements (121,321)).

FIG. 8 is an exemplary illustration of a conventional cathode flow and stack temperature distribution. In Planar SOFC (and SOEC), stacks (53) may suffer from large thermal gradients along the width and height of the stack (53) (perpendicular to the direction of flow). These thermal gradients may result from significant heat loss transferred through the stack faces to the ambient environment resulting in the edges (86) of the stack being much cooler than the core (87) (as shown in FIG. 8). This may be disadvantageous for several reasons, including reduced efficiency as a consequence of the edges (86) of the stack operating at lower (and less efficient) temperatures compared to the core, (87) a requirement to supply additional flow to the cathode to prevent the core (87) from over-heating, thermally induced stresses within the stack, (53) and the like.

For SOFC's, the cathode flow may operate as both an oxidizer for the electrochemical reaction, and as a heat transfer media to carry the heat generated by the electrochemical reaction out of the stack (53). The intent of the described embodiment is to create a non-uniform flow distribution across the cathode face to match the cathode flowrate in each area of the stack with the heat which may be carried away by the cathode flow. By doing this, the temperature across the width and height of the stack may be far more uniform compared to the conventional approach (e.g., constant distribution of cathode flow across this face). By maintaining a more uniform temperature, the efficiency of the system (51) may be improved by increasing the temperate of the stack (53) along the edges (86) closer to the optimal maximum temperature of the core, (87) reducing the required cathode flowrate (thereby reducing parasitic losses), and reducing the thermally induced mechanical stresses within the stack (53).

FIG. 9 is an exemplary illustration of a simplified representation of cathode air flow before and after it enters the stack, and temperature axial distribution for one embodiment of the present technology. The non-uniform cathode flow distribution described in this embodiment may be compensated by placing a device, such as at least one electrochemical cell stack axial flow adjuster or by accomplishing the step of establishing differential axial flow within at least one electrochemical cell stack. The electrochemical cell stack axial flow adjuster may be placed in the cathode flow stream, and is shown conceptually in FIG. 9 as a gradated distribution plate (99) and more literally in FIG. 11 as gradated distribution plate (444). This may more generally be at least one electrochemical cell axial flow adjustment plate or may be achieved by operation with the step of utilizing at least one electrochemical cell axial flow adjustment plate or the step of utilizing at least one gradated distribution plate, which may increase pressure drop around the stack edges (86) compared to the core (87). The plate or other electrochemical cell stack axial flow adjuster may be fixed, variable, or even replaceable, so embodiments can have at least one fixed gradated distribution plate or can achieve in operation the step of utilizing at least one fixed gradated distribution plate. Increasing pressure drop over an edge region of the stack (53) results in less cathode flow passing through these areas, and more flow in core regions with a lower pressure drop (under the same flow conditions) to achieve a more uniform flow throughout the stack (53).

The gradated distribution plate (99) may be created using multiple methods. One possible approach, represented in FIG. 9, features a plate with a series of holes which are larger in the center (that may result in more flow/heat transfer through the stack's core (87)), and gradually becoming smaller as they become closer to the stack edges (86) (resulting in less cathode flow/heat transfer in these areas). The distribution of flow may be optimized based on the stack's design and operating conditions; one conceptual example of gradation is shown in FIG. 10 where the lighter shading indicates a less restricted flow by the electrochemical cell stack axial flow adjuster.

The gradated distribution plate (99) may be placed either before or after the stack (53). Placing the distribution plate after the stack, (53) and slightly offset, may be preferred based on the flow dynamics which may result in a smoother flow field gradient. One possible implementation of the fixed gradated distribution plate (444) is shown in FIG. 11.

There are multiple embodiments of this basic concept of a electrochemical cell stack axial flow adjuster, and even a gradated distribution plate (99) or device. A electrochemical cell stack axial flow adjuster could be created in various ways including a plate with a variable distribution of holes (as previously described), a variable thickness porous material, by the step of utilizing a variable thickness porous material, by a set of screens which may include at least one stacked multiple screen component, by the step of utilizing at least one stacked multiple screen component, each with a circular hole in the center ranging from large to small and stacked on top of each to create the gradated pressure drop (to describe just a few). Regardless of the physical implementation of this device or electrochemical cell stack axial flow adjuster, the embodiment relates to the process of varying the cathode flow axially across the face of the stack to improve system performance.

In addition to the afore described fixed distribution device, (88) the flow distribution device (88) may also be passively or actively controlled. One embodiment of a controllable flow distribution device may include using two distribution plates placed on top of one another with pairs of openings which, when one plate is moved relative to the other, would either change the distribution of these openings, or change the relative size of these openings. Moving of these plates relative to one another may be accomplished either manually (e.g. as part of a tuning process) or controlled by some active or passive device to achieve the desired flow and/or temperature distribution and system operation. Other examples of passively or actively control flow distribution devices (88) are systems which may change the size of the holes, and by association pressure drop, based on the temperature coming through each section of the distribution plate (99 or otherwise). Example implementations include utilizing materials with high rates of thermal expansion, or actively controlled via piezoelectrics or the like.

In some embodiments control of the SOFC/GT system may be an important consideration to the system design. Related to the system's (51) control, some embodiments may include but are not limited to:
It may be beneficial that control strategies be robust, protect the system in the case of component failures, and be capable of adapting to variations in the system's performance as environmental conditions change and as the system ages.
Control strategies may maximize system performance and efficiency.
Control strategies may be able to adapt to varying electrical load demands.

A complex set of control strategies may be required to control the SOFC/GT system (51) effectively and robustly. Many of these strategies may employ known components. However, several of the embodiments may potentially be novel and add to the strengths of the described SOFC/GT system

For clarity in some embodiments the amount of electrical power produced by the SOFC/GT system (51) may be controlled by adjusting the amount of fuel (49) supplied to the system (51). The system (51) may likely predominantly be controlled to operate as efficiently as possible. One method for increasing efficiency may be to maximize the SOFC's efficiency and power production (as it produces electricity much more efficiently than the GT). Analysis has shown that the SOFC's efficiency may be maximized by maintaining the stack (53) at as high of a temperature as is permissible based on material constraints. This may be accomplished by implementing components such as the supervisory control system (68) at a closed loop controller which may even monitor the stacks' maximum temperature and may adjust the electric load placed on the stack (53) to maintain the desired temperature.

Analysis has also shown that the SOFC/GT system's efficiency may be maximized by maintaining the turbine inlet temperature at as high of a temperature as is permissible based on material constraints. This may be achieved with a closed loop controller which monitors turbine inlet temperature and adjusts the GT's speed to maintain the desire setpoint.

As an example, in some embodiments the system (51) may start at 90% power output and both the stack (53) and turbine inlet temperatures at their desired temperature values. The system may now transition from 90% to 100% output power by increasing the fuel flow accordingly. This fuel flow may first pass through the stacks, (53) which may be only mildly influenced by the change in fuel concentration, and continue to consume the same amount of fuel (49). However, now there may be more fuel leaving the stacks (53) and entering the combustor (12) causing a rise in turbine inlet temperature. A turbine inlet temperature controller of the supervisory control system (68) may then respond by increasing the speed/flow from the compressor (2) to dilute out the added heat and bring the turbine inlet temperature back down to the desired level. The increase in compressor flow through the stacks (53) may increase the heat being transported away from the stacks (53) resulting in a temperature drop within the stacks. A maximum stack temperature controller of the supervisory control system (68) may then increase the load placed on the stacks (53) to release more heat and bring the stacks (53) back up to temperature. Increasing the stack load consumes more fuel (49) resulting in less fuel flowing to the combustor, and consequently a lower turbine inlet temperature. These two control loops may work in unison to achieve a steady-state operational point where both the maximum stack temperature, and turbine inlet temperature, may reach their desired values (there may be only a single speed/stack load combination that results in this operation). If these are configured as closed loop controls and are properly designed and tuned, no significant oscillations may exist when changing power output levels. By using the described closed loop control strategies, the system's efficiency may be optimized using a relatively simple controls approach.

In some embodiments, a method for high efficiency power production may include, but is not limited to, the steps of: capturing heat energy and excess fuel from a SOFC; providing captured SOFC heat energy to the turbine flow path; capturing turbine waste heat for electro-chemical reaction in the SOFC; preheating the SOFC cathode flow; and determining and optimizing circulated heat from cathode outlet for utilization in other processes. These steps may be completed either manually by an operator or autonomously through passive or active controls. In some embodiments, parameters such as heat energy capture percentage may be accomplished through passive controls measuring waste heat flowrate or another system parameter such as temperature, fuel flow rate, fuel burn percentage, or the like.

As mentioned, a variety of electrochemical cells types and systems can be used in the embodiments. Some are detailed as follows:
(1) Solid oxide fuel cells: A fuel gas, which can be hydrogen, methane, and/or synthesis gas (H₂+CO), is fed to fuel electrode channels, air or oxygen is fed to oxygen electrode channels, oxygen is converted to oxygen ions at the oxygen electrodes, the oxygen ions conduct through the ceramic electrolyte, and these oxygen ions then oxidize fuel at the fuel electrodes. This provides a highly efficient means of generating electrical power from the fuel.
(2) High temperature steam electrolysis (or solid oxide electrolysis): Steam or a mixture of hydrogen and steam is fed to the fuel electrodes and electricity is applied between the fuel and oxygen electrodes so that oxygen ions are separated from steam at the fuel electrodes to form hydrogen, these oxygen ions conduct through the ceramic electrolyte and recombine to form oxygen molecules at the oxygen electrodes. Often times, a sweep gas (air or carbon dioxide) is passed through the oxygen electrode channels to sweep out the oxygen that is generated at the oxygen electrodes. The oxygen that is generated at the oxygen electrodes also can be collected This provides a highly efficient means of producing hydrogen from steam.
(3) Reversible solid oxide cells: It is also possible for solid oxide cells to operate reversibly in both fuel cell and electrolysis modes. For example, reversible solid oxide cells can be used for long term energy storage to support electrical grids with large amounts of intermittent renewable energy. The solid oxide cells generate hydrogen during times of low electricity demand and generate power at times of high electricity demand.
(4) High temperature co-electrolysis: Steam and carbon dioxide (or a mixture of steam, carbon dioxide and hydrogen) are fed the fuel electrodes and electricity is applied between the fuel and oxygen electrodes so that oxygen ions are separated from steam and carbon dioxide at the fuel electrodes to form hydrogen and carbon monoxide, these oxygen ions conduct through the ceramic electrolyte and recombine to form oxygen molecules at the oxygen electrodes. Often times, a sweep gas (air or carbon dioxide) is passed through the oxygen electrode channels to sweep out the oxygen that is generated at the oxygen electrodes. The oxygen that is generated at the oxygen electrodes also can be collected. This provides a highly efficient means of producing synthesis gas (hydrogen plus carbon monoxide) from steam and carbon dioxide; this synthesis gas then can be readily converted to liquid fuels and/or value added chemicals via commercially practiced chemical synthesis technologies.
(5) High temperature carbon dioxide electrolysis: Carbon dioxide is fed the fuel electrodes and electricity is applied between the fuel and oxygen electrodes so that oxygen ions are separated from carbon dioxide at the fuel electrodes to form carbon monoxide, these oxygen ions conduct through the ceramic electrolyte and recombine to form oxygen molecules at the oxygen electrodes. A sweep gas (air) is passed through the oxygen electrode channels to sweep out the oxygen that is generated at the oxygen electrodes. The oxygen that is generated at the oxygen electrodes also can be collected. This provides a highly efficient means of producing carbon monoxide (and oxygen) from carbon dioxide. The carbon monoxide created from CO₂ electrolysis can used as a feedstock for making liquid fuels and/or value added chemicals via commercially practiced chemical synthesis technologies. The oxygen that is produced from carbon dioxide can be used for life support (for example on Mars).
(6) Electrochemical separation of oxygen from air: This is another form of electrolysis, where air is fed to one set of electrode channels, electricity is applied between the electrodes so that oxygen ions created at one electrode, these oxygen ions are conducted through the ceramic electrolyte, and the oxygen ions are recombined to form oxygen molecules at the opposite electrodes. The purified oxygen then is collected.
   There are other types of electrochemical cells and stacks of electrochemical cells that the proposed technology can be used for. These include:
(1) High temperature proton-conducting ceramic electrolytes. For these types of electrochemical cells, the ceramic electrolyte is a proton conductor and the operating temperature is in the range of 500 to 600° C. For power generation in the fuel cell mode, hydrogen and air are fed to opposite electrodes, hydrogen molecules are converted to hydrogen ions (protons) at the fuel electrode, and protons conduct through the electrolyte membrane and react with oxygen to form steam at the oxygen electrode. For hydrogen production from steam, electricity is applied to the two electrodes, steam is fed to one set of electrode channels, hydrogen ions (protons) are separated from steam at the fuel electrodes, the protons are conducted through the electrolyte membrane to the opposite electrode where the protons recombine and form hydrogen molecules, and the hydrogen is collected.
(2) Molten carbonate fuel cells. For this type of electrochemical system, the electrolyte membrane is mixture of lithium and potassium carbonates, the conducting species are carbonate ions (CO₃), and the operating temperature is in the range of 600 to 700° C. In the fuel cell mode for power generation, oxygen reacts with CO₂ to form carbonate ions at the oxygen electrode, the carbonate ions conduct through the electrolyte to the fuel electrode, and hydrogen reacts with carbonate to form steam and carbon dioxide at the fuel electrode. In the electrolysis mode, steam and carbon dioxide react to form hydrogen and carbonate ions at the fuel electrode, the carbonate ions are conducted through the electrolyte to the oxygen electrode, and the carbonate ions are converted to carbon dioxide and oxygen at the oxygen electrode.
(3) Phosphoric acid fuel cells. For this type of fuel cell, the electrolyte membrane is phosphoric acid, the conducting species are hydrogen ions (protons), and the operating temperature is in the range of 150 to 200° C.
(4) Proton exchange membrane fuel cells and electrolyzers. For this type of electrochemical system, the electrolyte membrane is a polymeric material, the conducting species are hydrogen ions (protons), and the operating temperature usually is in the range of 60 to 80° C. Higher operating temperatures (10 to 200° C.) are also possible with different types of polymeric membranes.
(5) Alkaline fuel cells and electrolyzers. For this type of electrochemical system, the electrolyte membrane is an aqueous potassium hydroxide solution, the conducting species are hydroxyl ions (OH), and the operating temperature is in the range of 60 to 80° C.
   Thus, it should be understood that embodiments can include: generally solid oxide electrochemical cells, electrical power generation electrochemical cells, electrolysis cells, gaseous substance generation electrochemical cells, solid oxide fuel cells, or solid oxide electrolyzer cells. Similarly, operating the system can involve the steps of providing a plurality of electrical power generation electrochemical cell stacks, providing a plurality of gaseous substance generation electrochemical cell stacks, providing a plurality of connected individual solid oxide electrochemical cell stacks, providing a plurality of connected individual solid oxide fuel cell stacks, or providing a plurality of connected individual solid oxide electrolyzer cell stacks. Further the cells for any of the above either can be: proton exchange membrane cells, direct methanol cells, alkaline cells, phosphoric acid cells, molten carbonate cells, solid oxide cells, solid oxide protonic conducting cells, or high temperature proton exchange membrane cells. Similarly, operating the system can involve the step of providing a plurality of connected individual electrochemical cell stacks selected from: proton exchange membrane cell stacks, direct methanol cell stacks, alkaline cell stacks, phosphoric acid cell stacks, molten carbonate cell stacks, solid oxide cell stacks, solid oxide protonic conducting cells, and high temperature proton exchange membrane cell stacks.

In considering each of the configurations of embodiments possible, the following considerations may be helpful:
(1) For many solid oxide fuel cell and electrolysis applications, systems can be relatively large (hundreds of kilowatts to hundreds of megawatts in scale) and it is not practical to build a system compromising a single stack. Thus, multiple stacks or multiple modules comprised of multiple stacks may be required to be combined into a system. Thus, a key system design consideration can be the means for combining multiple stacks into modules, and for feeding reactant gases to each of the stacks or modules in the system. This invention describes useful approaches for achieving this modularity.
(2) Maximizing efficiency of solid oxide fuel cells and electrolyzers can require high reactant utilization (e.g., high fuel utilization for fuel cell mode operation or high steam utilization for electrolysis mode operation). For the case of high temperature electrolysis, some amount of hydrogen in the steam feed may be required to keep the nickel based fuel electrodes in their metallic state. For these reasons, reactant recycling approaches often are employed. This recycling can be achieved via physical means (blowers) or passive means (ejectors). Another recycling approach is cascading, whereby spent fuel and/or air exiting one stack are fed to the fuel and/or air inputs of a second stack.
(3) To those skilled in the art, electrodes in electrochemical cells typically are referred to as anodes and cathodes. Anodes are usually the electrodes where oxidation reactions happen and cathodes are the electrodes where reduction reactions happen. Thus, for fuel cell mode operation, the fuel electrodes may be anodes and the oxygen electrodes may be cathodes. For electrolysis mode operation, the fuel electrodes may be cathodes and the oxygen electrodes may be anodes. For simplicity and to avoid confusion, we have used fuel electrode and oxygen electrode terminology in this application.
(4) In the electrolysis modes, systems may have a steam input or may operate in a manner that achieves the step of utilizing a steam input in part of the process.

One embodiment of an electrolysis type of system is shown in FIG. 12. As can be understood, air can be provided such as by an air blower (412). This may be conditioned by an air recuperator (411) and then provided via an air heater (410) to be used in the process. The air may have its temperature increased, such as by an air recuperator, and even further increased via an air heater before the air is used in the process. Recuperated air may also be provided to the electrodes and the electrochemical cells and cell stacks as shown. Remainder may be vented through a vent stack (403) perhaps via some conditioning or dilution element (404). The steam input can be provided from a water source (401) into a steam generator (402) and then into a fuel recuperator (407) perhaps via fuel recirculation ejector (408) and then into a fuel heater (409) for ultimate use in the process. The heated fuel can be input to the electrodes and the electrochemical cells and cell stacks perhaps via manifold (414) as shown. Similarly air can be provided via manifold (413) as shown conceptually. Can be appreciated from the entire prior discussion relative to SOFC's, in this SOEC design, the electrodes and the electrochemical cells can have a air electrode outlet and a fuel electrode outlet (418) that can also be manifolded such as in manifolds (417) and (416). Again, the system can be controlled by power electronics (18) perhaps to supply power to the grid (22) if used for power generation. In addition, gas generation such as hydrogen and or oxygen can occur via a condenser or separator (405) and then provided to a customer via a supply (406). All can be contained in a containment vessel (9) with appropriate plenum as discussed previously.

While the present inventive technology has been described in connection with some preferred embodiments, it is not intended to limit the scope of the inventive technology to the particular form set forth, but on the contrary, it is intended to cover such alternatives, modifications, and equivalents, as may be included within the spirit and scope of the inventive technology as defined by the statements of inventions. Examples of clauses and alternative claims may include:

1. An electrochemical cell system for use in either power generation or electrolysis modes comprising:
a plurality of connected individual electrochemical cell stacks, each of said plurality of connected individual electrochemical cell stacks comprising:
   a plurality of first function electrode elements;
   a plurality of second function electrode elements;
   a stack first function electrode inlet;
   a stack first function electrode outlet;
   a stack second function electrode inlet;
   a stack second function electrode outlet,
a first function electrode outlet manifold connected to each of said stack first function electrode outlets;
a substantially fully accommodative thermal expansion-contraction second function electrode inlet manifold connected to each of said stack second function electrode inlets;
a substantially fully accommodative thermal expansion-contraction second function electrode outlet manifold connected to each of said stack second function electrode outlets;
a containment vessel configured to removably contain at least a portion of said plurality of connected individual electrochemical cell stacks; and
a fully dimensionally accommodative thermal expansion-contraction containment vessel interior space multiple electrochemical cell stack, stack first function electrode inlet plenum configured to establish a substantially equivalent environmental intake condition for each of said plurality of first function electrode elements.
   2. An electrochemical cell system as described in clause 1 or any other clause and further comprising:
an at least part vessel external compressive stack mount; and
a thermal barrier configured to substantially thermally isolate said at least part vessel external compressive stack mount.
   3. An electrochemical cell system as described in clause 1 or any other clause and further comprising an electrochemical cell support manifold.
   4. An electrochemical cell system as described in clause 3 or any other clause wherein said electrochemical cell support manifold comprises a manifold stack mount selected from:
a first function electrode outlet manifold stack mount;
a second function electrode inlet manifold stack mount; and
a second function electrode outlet manifold stack mount.
   5. An electrochemical cell system as described in clause 1 or any other clause wherein said electrochemical cells comprise electrical power generation electrochemical cells.
   6. An electrochemical cell system as described in clause 1 or any other clause wherein said electrochemical cells comprise gaseous substance generation electrochemical cells.
   7. An electrochemical cell system as described in clause 6 or any other clause and further comprising a steam input.
   8. An electrochemical cell system as described in clause 7 or any other clause and further comprising a substantially fully accommodative thermal expansion-contraction electrochemical cell slide element.
   9. An electrochemical cell system as described in clause 1 or any other clause and further comprising at least one electrochemical cell stack axial flow adjuster.
   10. An electrochemical cell system as described in clause 9 or any other clause wherein said at least one electrochemical cell stack axial flow adjuster comprises at least one gradated distribution plate.
   11. An electrochemical cell system for use in either power generation or electrolysis modes comprising:
a plurality of connected individual electrochemical cell stacks, each of said plurality of connected individual electrochemical cell stacks comprising:
   a plurality of first function electrode elements;
   a plurality of second function electrode elements;
   a stack first function electrode inlet;
   a stack first function electrode outlet;
   a stack second function electrode inlet;
   a stack second function electrode outlet,
a containment vessel configured to removably contain at least a portion of said plurality of connected individual electrochemical cell stacks; and
a containment vessel interior space multiple electrochemical cell stack, stack first function electrode inlet plenum.
   12. An electrochemical cell system as described in clause 11 or any other clause wherein said containment vessel interior space multiple electrochemical cell stack, stack first function electrode inlet plenum is configured to fully surround and contain each of said plurality of stack first function electrode inlets, each of said plurality of stack second function electrode inlets, and each of said plurality of stack second function electrode outlets.
   13. An electrochemical cell system as described in clause 11 or any other clause wherein each of said first function electrode elements comprise oxygen electrode elements, and or any other clause wherein each of said second function electrode elements comprise fuel electrode elements.
   14. An electrochemical cell system as described in clause 13 or any other clause wherein each of said oxygen electrode elements comprise cathode elements, and or any other clause wherein each of said fuel electrode elements comprise anode elements.
   15. An electrochemical cell system as described in clause 13 or any other clause wherein each of said oxygen electrode elements comprise anode elements, and or any other clause wherein each of said fuel electrode elements comprise cathode elements.
   16. An electrochemical cell system as described in clause 11 or any other clause wherein each of said first function electrode elements comprise fuel electrode elements, and or any other clause wherein each of said second function electrode elements comprise oxygen electrode elements.
   17. An electrochemical cell system as described in clause 13 or any other clause wherein each of said fuel electrode elements comprise cathode elements, and or any other clause wherein each of said oxygen electrode elements comprise anode elements.
   18. An electrochemical cell system as described in clause 13 or any other clause wherein each of said oxygen electrode elements comprise anode elements, and or any other clause wherein each of said fuel electrode elements comprise cathode elements.
   19. An electrochemical cell system as described in clause 11 or any other clause and further comprising:
a first function electrode outlet manifold connected to each of said stack first function electrode outlets;
a second function electrode inlet manifold connected to each of said stack second function electrode inlets; and
a second function electrode outlet manifold connected to each of said stack second function electrode outlets, and
   or any other clause wherein said containment vessel interior space multiple electrochemical cell stack, stack first function electrode inlet plenum is configured to surround each of said second function electrode inlets manifold, and said second function outlets.
   20. An electrochemical cell system as described in clause 19 or any other clause wherein said second function electrode inlet manifold, and said second function outlet manifold comprise substantially fully accommodative thermal expansion-contraction manifolds, and or any other clause wherein said containment vessel interior space multiple electrochemical cell stack, stack first function electrode inlet plenum comprises a fully dimensionally accommodative thermal expansion-contraction interior space.
   21. An electrochemical cell system as described in clause 11 or any other clause wherein said plurality of connected individual electrochemical cell stacks comprises a plurality of fluidically connected individual electrochemical cell stacks.
   22. An electrochemical cell system as described in clause 11 or any other clause wherein said plurality of connected individual electrochemical cell stacks comprises a plurality of electrically connected individual electrochemical cell stacks.
   23. An electrochemical cell system as described in clause 11 or any other clause wherein said plurality of connected individual electrochemical cell stacks comprises a plurality of fluidically and electrically connected individual electrochemical cell stacks.
   24. An electrochemical cell system as described in clause 11 or any other clause wherein said containment vessel interior space multiple electrochemical cell stack, stack first function electrode inlet plenum is configured to establish a substantially equivalent environmental intake condition for each of said plurality of first function electrode elements.
   25. An electrochemical cell system as described in clause 24 or any other clause and further comprising a first function electrode outlet manifold.
   26. An electrochemical cell system as described in clause 25 or any other clause wherein said first function electrode outlet manifold comprises an electrochemical cell support outlet manifold.
   27. An electrochemical cell system as described in clause 24 or any other clause and further comprising a substantially singular thermal expansion coefficient mount.
   28. An electrochemical cell system as described in clause 27 or any other clause wherein said substantially singular thermal expansion coefficient mount comprises a stack shelf on which each of said plurality of connected individual electrochemical cell stacks are mounted.
   29. An electrochemical cell system as described in clause 27 or any other clause wherein said substantially singular thermal expansion coefficient mount comprises a manifold stack mount.
   30. An electrochemical cell system as described in clause 29 or any other clause wherein said manifold stack mount comprises a manifold stack mount selected from:
a first function electrode outlet manifold stack mount;
a second function electrode inlet manifold stack mount; and
a second function electrode outlet manifold stack mount.
   31. An electrochemical cell system as described in clause 19 or any other clause wherein said first function electrode outlet manifold comprises a first function electrode outlet manifold stack mount.
   32. An electrochemical cell system as described in clause 24 or any other clause and further comprising a compressive stack mount.
   33. An electrochemical cell system as described in clause 32 or any other clause wherein said compressive stack mount comprises:
a compressive tie rod; and
a compression element.
   34. An electrochemical cell system as described in clause 33 or any other clause wherein said compressive stack mount further comprises a spring element.
   35. An electrochemical cell system as described in clause 32 or any other clause wherein said compressive stack mount comprises an at least part vessel external compressive stack mount.
   36. An electrochemical cell system as described in clause 34 or any other clause wherein said spring element comprises an at least part vessel external spring element.
   37. An electrochemical cell system as described in clause 35 or any other clause and further comprising a thermal barrier configured to substantially thermally isolate said at least part vessel external compressive stack mount.
   38. An electrochemical cell system as described in clause 35 or any other clause wherein said at least part vessel external compressive stack mount comprises a non-high temperature compressive stack mount.
   39. An electrochemical cell system as described in clause 41 or any other clause and further comprising a second function electrode outlet manifold connected to each of said stack second function electrode outlets.
   40. An electrochemical cell system as described in clause 39 or any other clause wherein said second function electrode outlet manifold comprises an interconnected second function electrode outlet manifold.
   41. An electrochemical cell system as described in clause 40 or any other clause wherein said containment vessel interior space multiple electrochemical cell stack, stack first function electrode inlet plenum is configured to surround at least a portion of said second function electrode outlet manifold.
   42. An electrochemical cell system as described in clause 39 or any other clause wherein said second function electrode outlet manifold comprises a substantially fully accommodative thermal expansion-contraction second function electrode outlet manifold.
   43. An electrochemical cell system as described in clause 11 or any other clause wherein said electrochemical cells comprise solid oxide electrochemical cells.
   44. An electrochemical cell system as described in clause 43 or any other clause wherein said solid oxide electrochemical cells comprise solid oxide fuel cells.
   45. An electrochemical cell system as described in clause 43 or any other clause wherein said solid oxide electrochemical cells comprise solid oxide electrolyzer cells.
   46. An electrochemical cell system as described in clause 11 or any other clause wherein said electrochemical cells comprise electrochemical cells selected from: proton exchange membrane cells, direct methanol cells, alkaline cells, phosphoric acid cells, molten carbonate cells, solid oxide cells, solid oxide protonic conducting cells, and high temperature proton exchange membrane cells.
   47. An electrochemical cell system as described in clause 11 or any other clause wherein said electrochemical cells comprise electrical power generation electrochemical cells.
   48. An electrochemical cell system as described in clause 11 or any other clause wherein said electrochemical cells comprise gaseous substance generation electrochemical cells.
   49. An electrochemical cell system as described in clause 47 or any other clause and further comprising:
a compressor; and
a turbine.
   50. An electrochemical cell system as described in clause 49 or any other clause and further comprising a turbine recuperator.
   51. An electrochemical cell system as described in clause 49 or any other clause and further comprising a cathode recuperator.
   52. An electrochemical cell system as described in clause 49 or any other clause and further comprising a desulfurizer.
   53. An electrochemical cell system as described in clause 49 or any other clause and further comprising a combustor.
   54. An electrochemical cell system as described in clause 49 or any other clause and further comprising a reformer.
   55. An electrochemical cell system as described in clause 49 or any other clause and further comprising an anode heat exchanger.
   56. An electrochemical cell system as described in clause 48 or any other clause and further comprising a steam input.
   57. An electrochemical cell system as described in clause 56 or any other clause and further comprising a cathode recuperator.
   58. An electrochemical cell system as described in clause 56 or any other clause and further comprising an anode heat exchanger.
   59. An electrochemical cell system as described in clause 11 or any other clause wherein said plurality of connected individual electrochemical cell stacks comprise a plurality of connected individual electrochemical cell stacks selected from:
series electrically connected electrochemical cell stacks;
series fluidically connected electrochemical cell stacks;
parallel electrically connected electrochemical cell stacks;
parallel fluidically connected electrochemical cell stacks; and all permutations and combinations of the above.
   60. An electrochemical cell system as described in clause 11 or any other clause and further comprising a fully accommodative thermal expansion-contraction electrochemical cell stack mount.
   61. An electrochemical cell system as described in clause 60 or any other clause wherein said fully accommodative thermal expansion-contraction electrochemical cell stack mount comprises a roller element.
   62. An electrochemical cell system as described in clause 60 or any other clause wherein said fully accommodative thermal expansion-contraction electrochemical cell stack mount comprises a slide element.
   63. An electrochemical cell system as described in clause 11 or any other clause and further comprising at least one electrochemical cell stack axial flow adjuster.
   64. An electrochemical cell system as described in clause 63 or any other clause wherein said at least one electrochemical cell stack axial flow adjuster comprises at least one electrochemical cell axial flow adjustment plate.
   65. An electrochemical cell system as described in clause 64 or any other clause wherein said at least one electrochemical cell axial flow adjustment plate comprises at least one gradated distribution plate.
   66. An electrochemical cell system as described in clause 65 or any other clause wherein said at least one gradated distribution plate comprises at least one fixed gradated distribution plate.
   67. An electrochemical cell system as described in clause 63 or any other clause wherein said at least one electrochemical cell stack axial flow adjuster comprises a variable thickness porous material.
   68. An electrochemical cell system as described in clause 63 or any other clause wherein said at least one electrochemical cell stack axial flow adjuster comprises at least one stacked multiple screen component.
   69. An electrochemical cell process comprising the steps of:
providing a plurality of connected individual electrochemical cell stacks, said plurality of connected individual electrochemical cell stacks each stack having:
   a plurality of first function electrode elements;
   a plurality of second function electrode elements;
   a stack first function electrode inlet;
   a stack first function electrode outlet;
   a stack second function electrode inlet; and
   a stack second function electrode outlet,
fully containing said plurality of connected individual electrochemical cell stacks by a containment vessel; and
establishing a containment vessel interior space multiple electrochemical cell stack, stack first function electrode inlet plenum within which is contained said plurality of stack first function electrode inlets.
   70. An electrochemical cell process as described in clause 69 or any other clause wherein said step of establishing a containment vessel interior space multiple electrochemical cell stack, stack first function electrode inlet plenum comprises the step of fully surrounding and containing each of said plurality of stack first function electrode inlets, and each of said plurality of stack second function electrode outlets.
   71. An electrochemical cell process as described in clause 69 or any other clause wherein each of said first function electrode elements comprise oxygen electrode elements, and or any other clause wherein each of said second function electrode elements comprise fuel electrode elements.
   72. An electrochemical cell process as described in clause 71 or any other clause wherein each of said oxygen electrode elements comprise cathode elements, and or any other clause wherein each of said fuel electrode elements comprise anode elements.
   73. An electrochemical cell process as described in clause 71 or any other clause wherein each of said oxygen electrode elements comprise anode elements, and or any other clause wherein each of said fuel electrode elements comprise cathode elements.
   74. An electrochemical cell process as described in clause 69 or any other clause wherein each of said first function electrode elements comprise fuel electrode elements, and or any other clause wherein each of said second function electrode elements comprise oxygen electrode elements.
   75. An electrochemical cell process as described in clause 71 or any other clause wherein each of said fuel electrode elements comprise cathode elements, and or any other clause wherein each of said oxygen electrode elements comprise anode elements.
   76. An electrochemical cell process as described in clause 71 or any other clause wherein each of said oxygen electrode elements comprise anode elements, and or any other clause wherein each of said fuel electrode elements comprise cathode elements.
   77. An electrochemical cell process as described in clause 69 or any other clause and further comprising the steps of:
establishing a first function electrode outlet manifold;
connecting said first function electrode outlet manifold to each of said stack first function electrode outlets;
establishing a second function electrode inlet manifold; and
connecting said second function electrode inlet manifold to each of said stack second function electrode inlets;
establishing a second function electrode outlet manifold;
connecting said second function electrode outlet manifold to each of said stack second function electrode outlets, and
   or any other clause wherein said step of establishing a containment vessel interior space multiple electrochemical cell stack, stack first function electrode inlet plenum comprises the steps of
surrounding at least a portion of said second function electrode inlet manifold, and
surrounding at least a portion of said second function electrode outlet manifold.
   78. An electrochemical cell process as described in clause 77 or any other clause and further comprising the steps of:
substantially fully accommodatively thermally expanding and contracting at least a portion of said second function electrode inlet manifold within said containment vessel interior space multiple electrochemical cell stack, stack first function electrode inlet plenum; and
substantially fully accommodatively thermally expanding and contracting at least a portion of said second function electrode outlet manifold within said containment vessel interior space multiple electrochemical cell stack, stack first function electrode inlet plenum.
   79. An electrochemical cell process as described in clause 69 or any other clause wherein said step of providing a plurality of connected individual electrochemical cell stacks comprises the step of fluidically connecting said plurality of connected individual electrochemical cell stacks.
   80. An electrochemical cell process as described in clause 69 or any other clause wherein said step of providing a plurality of connected individual electrochemical cell stacks comprises the step of electrically connecting said plurality of connected individual electrochemical cell stacks.
   81. An electrochemical cell process as described in clause 69 or any other clause wherein said step of providing a plurality of connected individual electrochemical cell stacks comprises the steps of:
fluidically connecting said plurality of connected individual electrochemical cell stacks; and
electrically connecting said plurality of connected individual electrochemical cell stacks.
   82. An electrochemical cell process as described in clause 69 or any other clause wherein said step of establishing a containment vessel interior space multiple electrochemical cell stack, stack first function electrode inlet plenum comprises the step of establishing a substantially equivalent environmental inlet condition for each of said first function electrode elements.
   83. An electrochemical cell process as described in clause 82 or any other clause and further comprising the step of establishing a first function electrode outlet manifold.
   84. An electrochemical cell process as described in clause 83 or any other clause wherein said step of establishing a first function electrode outlet manifold comprises the step of supporting said electrochemical cell stacks by said first function electrode outlet manifold.
   85. An electrochemical cell process as described in clause 82 or any other clause and further comprising the step of mounting said plurality of connected individual electrochemical cell stacks by a substantially singular thermal expansion coefficient mount.
   86. An electrochemical cell process as described in clause 85 or any other clause wherein said step of mounting said plurality of connected individual electrochemical cell stacks by a substantially singular thermal expansion coefficient mount comprises the step of utilizing a stack shelf on which each of said plurality of connected individual electrochemical cell stacks are mounted.
   87. An electrochemical cell process as described in clause 85 or any other clause wherein said step of mounting said plurality of connected individual electrochemical cell stacks by a substantially singular thermal expansion coefficient mount comprises the step of utilizing a manifold stack mount.
   88. An electrochemical cell process as described in clause 87 or any other clause wherein said step of utilizing a manifold stack mount comprises a step selected from:
utilizing a first function electrode outlet manifold stack mount;
utilizing a second function electrode inlet manifold stack mount; and
utilizing a second function electrode outlet manifold stack mount.
   89. An electrochemical cell process as described in clause 77 or any other clause wherein said step of establishing a first function electrode outlet manifold comprises the step of establishing a first function electrode outlet manifold stack mount.
   90. An electrochemical cell process as described in clause 82 or any other clause and further comprising the step of compressing each of said connected individual electrochemical cell stacks.
   91. An electrochemical cell process as described in clause 90 or any other clause wherein said step of compressing each of said connected individual electrochemical cell stacks comprises the steps of:
utilizing a compressive tie rod; and
utilizing a compression element.
   92. An electrochemical cell process as described in clause 91 or any other clause wherein said step of utilizing a compression element comprises the step of utilizing a spring element.
   93. An electrochemical cell process as described in clause 90 or any other clause wherein said step of compressing each of said connected individual electrochemical cell stacks comprises the step of at least part vessel external compressing each of said connected individual electrochemical cell stacks.
   94. An electrochemical cell process as described in clause 92 or any other clause wherein said step of utilizing a spring element comprises the step of at least part vessel external utilizing a spring element.
   95. An electrochemical cell process as described in clause 93 or any other clause and further comprising the step of substantially thermally isolating said step of at least part vessel external compressing each of said connected individual electrochemical cell stacks from said containment vessel interior space multiple electrochemical cell stack, stack first function electrode inlet plenum.
   96. An electrochemical cell process as described in clause 93 or any other clause wherein said step of at least part vessel external compressing each of said connected individual electrochemical cell stacks comprises the step of non-high temperature compressing each of said connected individual electrochemical cell stacks.
   97. An electrochemical cell process as described in clause 82 or any other clause and further comprising the step of establishing a second function electrode outlet manifold.
   98. An electrochemical cell process as described in clause 97 or any other clause wherein said step of establishing a second function electrode outlet manifold comprises the step of utilizing an electrochemical cell stack interconnected second function electrode outlet manifold.
   99. An electrochemical cell process as described in clause 98 or any other clause wherein said step of establishing a containment vessel interior space multiple electrochemical cell stack, stack first function electrode inlet plenum comprises the step of surrounding at least a portion of said second function electrode outlet manifold.
   100. An electrochemical cell process as described in clause 69 or any other clause wherein said step of establishing a second function electrode outlet manifold comprises the step of substantially fully accommodatively thermally expanding and contracting said second function electrode outlet manifold within said containment vessel interior space multiple electrochemical cell stack, stack first function electrode inlet plenum.
   101. An electrochemical cell process as described in clause 69 or any other clause wherein said step of providing a plurality of connected individual electrochemical cell stacks comprises the step of providing a plurality of connected individual solid oxide electrochemical cell stacks.
   102. An electrochemical cell process as described in clause 101 or any other clause wherein said step of providing a plurality of connected individual solid oxide electrochemical cell stacks comprises the step of providing a plurality of connected individual solid oxide fuel cell stacks.
   103. An electrochemical cell process as described in clause 101 or any other clause wherein said step of providing a plurality of connected individual solid oxide electrochemical cell stacks comprises the step of providing a plurality of connected individual solid oxide electrolyzer cell stacks.
   104. An electrochemical cell process as described in clause 69 or any other clause wherein said step of providing a plurality of connected individual electrochemical cell stacks comprises the step of providing a plurality of connected individual electrochemical cell stacks selected from: proton exchange membrane cell stacks, direct methanol cell stacks, alkaline cell stacks, phosphoric acid cell stacks, molten carbonate cell stacks, solid oxide cell stacks, solid oxide protonic conducting cells, and high temperature proton exchange membrane cell stacks.
   105. An electrochemical cell process as described in clause 69 or any other clause wherein said step of providing a plurality of connected individual electrochemical cell stacks comprises the step of providing a plurality of electrical power generation electrochemical cell stacks.
   106. An electrochemical cell process as described in clause 69 or any other clause wherein said step of providing a plurality of connected individual electrochemical cell stacks comprises the step of providing a plurality of gaseous substance generation electrochemical cell stacks.
   107. An electrochemical cell process as described in clause 105 or any other clause and further comprising the steps of:
utilizing a compressor in part of said process; and
utilizing a turbine in part of said process.
   108. An electrochemical cell process as described in clause 107 or any other clause and further comprising the step of utilizing a turbine recuperator in part of said process.
   109. An electrochemical cell process as described in clause 107 or any other clause and further comprising the step of utilizing a cathode recuperator in part of said process.
   110. An electrochemical cell process as described in clause 107 or any other clause and further comprising the step of utilizing a desulfurizer in part of said process.
   111. An electrochemical cell process as described in clause 107 or any other clause and further comprising the step of utilizing a combustor in part of said process.
   112. An electrochemical cell process as described in clause 107 or any other clause and further comprising the step of utilizing a reformer in part of said process.
   113. An electrochemical cell process as described in clause 107 or any other clause and further comprising the step of utilizing an anode heat exchanger in part of said process.
   114. An electrochemical cell process as described in clause 108 or any other clause and further comprising the step of utilizing a steam input in part of said process.
   115. An electrochemical cell process as described in clause 114 or any other clause and further comprising the step of utilizing a cathode recuperator in part of said process.
   116. An electrochemical cell process as described in clause 114 or any other clause and further comprising the step of utilizing an anode heat exchanger in part of said process.
   117. An electrochemical cell process as described in clause 69 or any other clause wherein said step of providing a plurality of connected individual electrochemical cell stacks comprises a step selected from the steps of:
providing series electrically connected electrochemical cell stacks;
providing series fluidically connected electrochemical cell stacks;
providing parallel electrically connected electrochemical cell stacks;
providing parallel fluidically connected electrochemical cell stacks; and
all permutations and combinations of the above.
   118. An electrochemical cell process as described in clause 69 or any other clause and further comprising the step of substantially fully accommodatively thermally expanding and contracting said plurality of connected individual electrochemical cell stacks within said containment vessel interior space multiple electrochemical cell stack, stack first function electrode inlet plenum.
   119. An electrochemical cell process as described in clause 118 or any other clause wherein said step of substantially fully accommodatively thermally expanding and contracting said plurality of connected individual electrochemical cell stacks within said containment vessel interior space multiple electrochemical cell stack, stack first function electrode inlet plenum comprises the step of rolling componentry within said containment vessel.
   120. An electrochemical cell process as described in clause 118 or any other clause wherein said step of substantially fully accommodatively thermally expanding and contracting said plurality of connected individual electrochemical cell stacks within said containment vessel interior space multiple electrochemical cell stack, stack first function electrode inlet plenum comprises the step of sliding componentry within said containment vessel.
   121. An electrochemical cell process as described in clause 69 or any other clause and further comprising the step of establishing differential axial flow within at least one electrochemical cell stack.
   122. An electrochemical cell process as described in clause 121 or any other clause wherein said step of establishing differential axial flow within at least one electrochemical cell stack comprises the step of utilizing at least one electrochemical cell axial flow adjustment plate.
   123. An electrochemical cell process as described in clause 122 or any other clause wherein said step of utilizing at least one electrochemical cell axial flow adjustment plate comprises the step of utilizing at least one gradated distribution plate.
   124. An electrochemical cell process as described in clause 123 or any other clause wherein said step of utilizing at least one gradated distribution plate comprises the step of utilizing at least one fixed gradated distribution plate.
   125. An electrochemical cell process as described in clause 121 or any other clause wherein said step of establishing differential axial flow within at least one electrochemical cell stack comprises the step of utilizing a variable thickness porous material.
   126. An electrochemical cell process as described in clause 121 or any other clause wherein said step of establishing differential axial flow within at least one electrochemical cell comprises the step of utilizing at least one stacked multiple screen component.

As can be easily understood from the foregoing, the basic concepts of the various embodiments of the present invention(s) may be embodied in a variety of ways. It involves both integrated solid oxide fuel cell-gas turbine techniques as well as devices to accomplish the appropriate integrated solid oxide fuel cell-gas turbine. In this application, the integrated solid oxide fuel cell-gas turbine techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the various embodiments of the invention(s) and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms such as the word substantially or the like, should be understood as also encompassing more precise and even quantitative values that include various levels of precision and the possibility of claims that address a number of quantitative options and alternatives. For example, to the extent ultimately used, the existence of a condition as being substantially fully expansion-contraction accommodative can be specified using percentage values that include 99%, 97%, 95%, or even 90% of the specified accommodation or condition. Again, these are implicitly included in this disclosure and should (and, it is believed, would) be understood to a person of ordinary skill in this field. Further, where the application is described in device-oriented terminology, each element of the device implicitly performs a function. Apparatus claims may not only be included for the device described, but also method or process claims may be included to address the functions of the embodiments and that each element performs. Neither the description nor the terminology is intended to limit the scope of the claims that will be included in any subsequent patent application.

It should also be understood that a variety of changes may be made without departing from the essence of the various embodiments of the invention(s). Such changes are also implicitly included in the description. They still fall within the scope of the various embodiments of the invention(s). A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of embodiments of the invention(s) both independently and as an overall system.

Further, each of the various elements of the embodiments of the invention(s) and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the various embodiments of the invention(s), the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which embodiments of the invention(s) is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “compressor” should be understood to encompass disclosure of the act of “compressing”—whether explicitly discussed or not—and, conversely, were there effectively disclosure of the act of compressing”, such a disclosure should be understood to encompass disclosure of a “compressor” and even a “means for compressing.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function. As other non-limiting examples, it should be understood that claim elements can also be expressed as any of: components, programming, subroutines, logic, or elements that are configured to, or configured and arranged to, provide or even achieve a particular result, use, purpose, situation, function, or operation, or as components that are capable of achieving a particular activity, result, use, purpose, situation, function, or operation. All should be understood as within the scope of this disclosure and written description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the List of References To Be Incorporated By Reference or other information statement filed with the application are hereby appended and hereby incorporated by reference, however, as to each of the above, to the extent that such information or statements incorporated by reference might be considered inconsistent with the patenting of the various embodiments of invention(s) such statements are expressly not to be considered as made by the applicant(s).

### LIST OF REFERENCES TO BE INCORPORATED BY REFERENCE

I. US PATENTS

| Patent No. | Patentee |
|---|---|
| 10644331 | Boeing Co. |
| 6641084 | Boeing Co. |
| 6834831 | Sumco Corp |
| 7380749 | Boeing Co |
| 7410713 | General Electric Co |
| 7966830 | Boeing Co |
| 8016228 | Boeing Co |
| 6213234 | Capstone Green Energy Corp |
| 6230494 | Aptiv Technologies Ltd |
| 6609582 | Delphi Technologies Inc |
| 6655235 | Commscope EMEA Ltd |
| | Commscope Technologies LLC |
| 7743861 | Delphi Technologies Inc |
| 5449568 | US Department of Energy |
| 6365290 | Fuelcell Energy Inc |
| 5968680 | Honeywell International Inc |
| | Hybrid Power Generation Systems LLC |
| 7153599 | General Electric Co |
| 7595124 | General Electric Co |
| 7118818 | LG Fuel Cell Systems Inc |
| 9570766 | LG Electronics Inc |
| 9666885 | LG Electronics Inc |
| 10107190 | Mitsubishi Power Ltd |
| 10490832 | Mitsubishi Power Ltd |
| 10533495 | Mitsubishi Power Ltd |
| 10804549 | Mitsubishi Power Ltd |
| 10914233 | Mitsubishi Power Ltd |
| 9422862 | Mitsubishi Power Ltd |
| 9482110 | Mitsubishi Power Ltd |
| 9482159 | Mitsubishi Power Ltd |
| 9638102 | Mitsubishi Power Ltd |
| 9768454 | Mitsubishi Power Ltd |
| 9777629 | Mitsubishi Power Ltd |
| 9806358 | Mitsubishi Power Ltd |
| 9831505 | Mitsubishi Power Ltd |
| 9926844 | Mitsubishi Power Ltd |
| 9945265 | Mitsubishi Power Ltd |
| 9979033 | Mitsubishi Power Ltd |
| 7781115 | Siemens Energy Inc |
| 5413879 | Siemens AG |
| 5532573 | Westinghouse Electric Co LLC |
| 5955039 | Siemens Energy Inc |
| 6255010 | Siemens Energy Inc |
| 7709118 | Siemens Energy Inc |
| 5693201 | ZTEK Corp |
| 5948221 | ZTEK Corp |
| 5976332 | ZTEK Corp |
| 5413879 | Domeracki et al. |
| 5449568 | Micheli et al. |
| 5532573 | Brown et al. |
| 5693201 | Hsu et al. |
| 5948221 | Hsu |
| 5955039 | Dowdy |
| 5968680 | Wolfe et al. |
| 5976332 | Hsu et al. |
| 6213234 | Rosen et al. |
| 6230494 | Botti et al. |
| 6255010 | George et al. |
| 6365290 | Ghezel-Ayagh et al. |
| 6609582 | Botti et al |
| 6641084 | Huber et al. |
| 6655235 | Botti et al. |
| 6834831 | Daggett |
| 7118818 | Agnew et al. |
| 7153599 | Bunker et al. |
| 7380749 | Fucke et al. |
| 7410713 | Balan et al. |
| 7595124 | Varatharajan et al. |
| 7709118 | Lundberg |
| 7743861 | Grieve |
| 7781115 | Lundberg |
| 7966830 | Daggett |
| 8016228 | Fucke et al. |
| 9422862 | Ozawa |
| 9482110 | Ozawa |
| 9482159 | Ozawa |
| 9570766 | Bozzolo et al. |
| 9638102 | Kobayashi et al. |
| 9666885 | Bozzolo et al. |
| 9768454 | Nagaie et al. |
| 9777629 | Nakamoto et al. |
| 9806358 | Nakamoto et al. |
| 9831505 | Nakamoto et al. |
| 9926844 | Fujita |
| 9945265 | Nakamoto et al. |
| 9979033 | Manabe et al. |
| 10107190 | Manabe et al. |
| 10490832 | Manabe et al. |
| 10533495 | Nakamoto et al. |
| 10644331 | Stoia et al. |
| 10804549 | Nakamoto et al. |
| 10914233 | Manabe et al. |

II. NON PATENT LITERATURE

U.S. Provisional Patent Application No. 63/297525
filed Jan. 7, 2022. First named
inventor: ECHTER.

Thus, the applicant(s) should be understood to have support to claim and make claims to embodiments including at least: i) each of the integrated solid oxide fuel cell-gas turbine devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming or other electronic automation, it should be understood that in characterizing these and all other aspects of the various embodiments of the invention(s)—whether characterized as a device, a capability, an element, or otherwise, because all of these can be implemented via software, hardware, or even firmware structures as set up for a general purpose computer, a programmed chip or chipset, an ASIC, application specific controller, subroutine, logic, or other known programmable or circuit specific structure—it should be understood that all such aspects are at least defined by structures including, as person of ordinary skill in the art would well recognize: hardware circuitry, firmware, programmed application specific components, and even a general purpose computer programmed to accomplish the identified aspect. For such items implemented by programmable features, the applicant(s) should be understood to have support to claim and make a statement of invention to at least: xv) processes performed with the aid of or on a computer, machine, or computing machine as described throughout the above discussion, xvi) a programmable apparatus as described throughout the above discussion, xvii) a computer readable memory encoded with data to direct a computer comprising means or elements which function as described throughout the above discussion, xviii) a computer, machine, or computing machine configured as herein disclosed and described, xix) individual or combined subroutines, processor logic, and/or programs as herein disclosed and described, xx) a carrier medium carrying computer readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) a processor executing instructions that act to achieve the steps and activities detailed, xxvi) circuitry configurations (including configurations of transistors, gates, and the like) that act to sequence and/or cause actions as detailed, xxvii) computer readable medium(s) storing instructions to execute the steps and cause activities detailed, xxviii) the related methods disclosed and described, xxix) similar, equivalent, and even implicit variations of each of these systems and methods, xxx) those alternative designs which accomplish each of the functions shown as are disclosed and described, xxxi) those alternative designs and methods which accomplish each of the functions shown as are implicit to accomplish that which is disclosed and described, xxxii) each feature, component, and step shown as separate and independent inventions, and xxxiii) the various combinations of each of the above and of any aspect, all without limiting other aspects in addition.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakimi v. Cannon Avent Group, PLC, 479 F.3 d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrases “comprising”, “including”, “containing”, “characterized by” and “having” are used to maintain the “open-end” claims herein, according to traditional claim interpretation including that discussed in MPEP § 2111.03. Thus, unless the context requires otherwise, it should be understood that the terms “comprise” or variations such as “comprises” or “comprising”, “include” or variations such as “includes” or “including”, “contain” or variations such as “contains” and “containing”, “characterized by” or variations such as “characterizing by”, “have” or variations such as “has” or “having”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 9 or any other claim” or the like, it could be re-drafted as dependent on claim 1, claim 8, or even claim 11 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the various embodiments of the application, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An electrochemical cell system for use in either power generation or electrolysis modes comprising:
a plurality of connected individual electrochemical cell stacks, each of said plurality of connected individual electrochemical cell stacks comprising:
a plurality of first function electrode elements;
a plurality of second function electrode elements;
a stack first function electrode inlet;
a stack first function electrode outlet;
a stack second function electrode inlet;
a stack second function electrode outlet,
a first function electrode outlet manifold connected to each of said stack first function electrode outlets;
a substantially fully accommodative thermal expansion-contraction second function electrode inlet manifold connected to each of said stack second function electrode inlets;
a substantially fully accommodative thermal expansion-contraction second function electrode outlet manifold connected to each of said stack second function electrode outlets;
a containment vessel configured to removably contain at least a portion of said plurality of connected individual electrochemical cell stacks; and
a fully dimensionally accommodative thermal expansion-contraction containment vessel interior space multiple electrochemical cell stack, stack first function electrode inlet plenum configured to establish a substantially equivalent environmental intake condition for each of said plurality of first function electrode elements.

2. An electrochemical cell system as described in claim 1 and further comprising:
an at least part vessel external compressive stack mount; and
a thermal barrier configured to substantially thermally isolate said at least part vessel external compressive stack mount.

3. An electrochemical cell system as described in claim 1 and further comprising an electrochemical cell support manifold.

4. An electrochemical cell system as described in claim 3 wherein said electrochemical cell support manifold comprises a manifold stack mount selected from:
a first function electrode outlet manifold stack mount;
a second function electrode inlet manifold stack mount; and
a second function electrode outlet manifold stack mount.

5. An electrochemical cell system as described in claim 1 wherein said electrochemical cells comprise electrical power generation electrochemical cells.

6. An electrochemical cell system as described in claim 1 wherein said electrochemical cells comprise gaseous substance generation electrochemical cells.

7. An electrochemical cell system as described in claim 6 and further comprising a steam input.

8. An electrochemical cell system as described in claim 7 and further comprising substantially fully accommodative thermal expansion-contraction electrochemical cell slide element.

9. An electrochemical cell system as described in claim 1 and further comprising at least one electrochemical cell stack axial flow adjuster.

10. An electrochemical cell system as described in claim 9 wherein said at least one electrochemical cell stack axial flow adjuster comprises at least one gradated distribution plate.

11. An electrochemical cell system for use in either power generation or electrolysis modes comprising:
a plurality of connected individual electrochemical cell stacks, each of said plurality of connected individual electrochemical cell stacks comprising:
a plurality of first function electrode elements;
a plurality of second function electrode elements;
a stack first function electrode inlet;
a stack first function electrode outlet;
a stack second function electrode inlet;
a stack second function electrode outlet,
a containment vessel configured to removably contain at least a portion of said plurality of connected individual electrochemical cell stacks; and
a containment vessel interior space multiple electrochemical cell stack, stack first function electrode inlet plenum.

12. An electrochemical cell system as described in claim 11 wherein each of said first function electrode elements comprise oxygen electrode elements, and wherein each of said second function electrode elements comprise fuel electrode elements.

13. An electrochemical cell system as described in claim 12 and further comprising substantially fully accommodative thermal expansion-contraction manifolds, and wherein said containment vessel interior space multiple electrochemical cell stack, stack first function electrode inlet plenum comprises a fully dimensionally accommodative thermal expansion-contraction interior space.

14. An electrochemical cell system as described in claim 11 wherein said containment vessel interior space multiple electrochemical cell stack, stack first function electrode inlet plenum is configured to establish a substantially equivalent environmental intake condition for each of said plurality of first function electrode elements.

15. An electrochemical cell system as described in claim 14 and further comprising a first function electrode outlet manifold.

16. An electrochemical cell system as described in claim 14 and further comprising a substantially singular thermal expansion coefficient mount.

17. An electrochemical cell system as described in claim 14 and further comprising a compressive stack mount.

18. An electrochemical cell system as described in claim 17 wherein said compressive stack mount comprises an at least part vessel external compressive stack mount.

19. An electrochemical cell system as described in claim 18 wherein said at least part vessel external compressive stack mount comprises an at least part vessel external spring element.

20. An electrochemical cell system as described in claim 18 and further comprising a thermal barrier configured to substantially thermally isolate said at least part vessel external compressive stack mount.

21. An electrochemical cell system as described in claim 11 wherein said electrochemical cells comprise electrochemical cells selected from: proton exchange membrane cells, direct methanol cells, alkaline cells, phosphoric acid cells, molten carbonate cells, solid oxide cells, solid oxide protonic conducting cells, and high temperature proton exchange membrane cells.

22. An electrochemical cell system as described in claim 11 and further comprising a fully accommodative thermal expansion-contraction electrochemical cell stack mount.

23. An electrochemical cell system as described in claim 11 and further comprising at least one electrochemical cell stack axial flow adjuster.

24. An electrochemical cell process comprising the steps of:
providing a plurality of connected individual electrochemical cell stacks, said plurality of connected individual electrochemical cell stacks each stack having:
a plurality of first function electrode elements;
a plurality of second function electrode elements;
a stack first function electrode inlet;
a stack first function electrode outlet;
a stack second function electrode inlet; and
a stack second function electrode outlet,
fully containing said plurality of connected individual electrochemical cell stacks by a containment vessel; and
establishing a containment vessel interior space multiple electrochemical cell stack, stack first function electrode inlet plenum within which is contained said plurality of stack first function electrode inlets.
